(19) United States
(12) Patent Application Publication
(10) Pub. No.: US 2024/0411994 A1
(43) Pub. Date: Dec. 12, 2024

(54) EXTRACTING INFORMATION FROM REPORTS USING LARGE LANGUAGE MODELS

(71) Applicant: NEC Laboratories Europe GmbH, Heidelberg (DE)

(72) Inventors: Giuseppe Siracusano, Heidelberg (DE); Davide Sanvito, Heidelberg (DE); Roberto Gonzalez Sanchez, Heidelberg (DE); Roberto Bifulco, Heidelberg (DE)

(21) Appl. No.: 18/457,381

(22) Filed: Aug. 29, 2023

Related U.S. Application Data
(60) Provisional application No. 63/471,532, filed on Jun. 7, 2023.

(51) Int. Cl. G06F 40/295; G06F 40/205

(52) U.S. Cl. CPC G06F 40/295; G06F 40/205

(57) ABSTRACT

A computer-implemented method for extracting and mapping structured information to a data model includes obtaining text data from one or more unstructured data sources. Rephrased text data is determined using a Large Language Model (LLM), a preprocessing prompt, and the text data. Extracted data is determined using the LLM, an extraction prompt, the data model, and the rephrased text data. The extracted data is mapped to the data model. The method can be applied, for example, to medical use cases or cyberthreat detection, among others, to improve the data models and support decision making.

### CROSS-REFERENCE TO RELATED APPLICATION

Priority is claimed to U.S. Provisional Patent Application No. 63/471,532, filed on Jun. 7, 2023, the entire disclosure of which is hereby incorporated by reference herein.

### FIELD

The present invention relates to a method, system and computer-readable medium for extraction of information from reports, such as security reports or medical records, using machine learning-artificial intelligence (ML-AI) models.

### BACKGROUND

Cyber threat intelligence (CTI) provides security operators with the information they need to protect against cyber threats and react to attacks. When structured in a standard format, such as structured threat information expression (STIX), CTI can be used with automated tools and for efficient search and analysis. However, while many sources of CTI are structured and contain indicators of compromise (IoCs), such as block lists of internet protocol (IP) addresses and malware signatures, helpful CTI is usually presented in an unstructured format, e.g., text reports and articles.

This form of CTI can be helpful to security operators, since it includes information about the attackers (threat actors) and victims (targets), and how the attack is performed: tools (malwares) and attack patterns. Ultimately, this is the information that can enable threat hunting activities.

### SUMMARY

In an embodiment, the present invention provides a computer-implemented method for extracting and mapping structured information to a data model. Text data is obtained from one or more unstructured data sources. Rephrased text data is determined using a Large Language Model (LLM), a preprocessing prompt, and the text data. Extracted data is determined using the LLM, an extraction prompt, the data model, and the rephrased text data. The extracted data is mapped to the data model. The method can be applied, for example, to medical use cases or cyberthreat detection, among others, to improve the data models and support decision making.

### BRIEF DESCRIPTION OF THE DRAWINGS

Embodiments of the present invention will be described in even greater detail below based on the exemplary figures. The present invention is not limited to the exemplary embodiments. All features described and/or illustrated herein can be used alone or combined in different combinations in embodiments of the present invention. The features and advantages of various embodiments of the present invention will become apparent by reading the following detailed description with reference to the attached drawings which illustrate the following:

FIG. 1 illustrates an example of a manual pipeline for extracting structured CTI;

FIG. 2 illustrates an example of a pipeline adopted for automated CTI extraction;

FIG. 3 illustrates an example of a global system according to one or more embodiments of the present invention;

FIG. 4 illustrates another example of a global system according to one or more embodiments of the present invention;

FIG. 5 illustrates a Large Language Model (LLM) agent according to one or more embodiments of the present invention;

FIG. 6 illustrates a portion of a STIX ontology according to one or more embodiments of the present invention;

FIG. 7 illustrates an example of a published security report;

FIG. 8 illustrates a STIX bundle representing the security report of FIG. 7;

FIG. 9 is a block diagram of an exemplary processing system, which can be configured to perform any and all operations disclosed herein according to one or more embodiments of the present invention;

FIG. 10 illustrates schematically a structured CTI information extraction tool according to one or more embodiments of the present invention;

FIG. 11 illustrates the performance for malware entity extraction of a structured CTI information extraction tool according to one or more embodiments of the present invention compared to other tools;

FIG. 12 illustrates the performance for threat actor entity extraction of a structured CTI information extraction tool according to one or more embodiments of the present invention compared to other tools;

FIG. 13 illustrates the performance for target entity extraction of a structured CTI information extraction tool according to one or more embodiments of the present invention compared to LADDER;

FIG. 14a illustrates the total number of attack patterns extracted by a structured CTI information extraction tool according to one or more embodiments of the present invention compared to other tools;

FIG. 14b illustrates the performance for attack pattern entity extraction of a structured CTI information extraction tool according to one or more embodiments of the present invention compared to other tools;

FIG. 15 illustrates the ablation for malware extraction of structured CTI information extraction tools according to embodiments of the present invention;

FIG. 16 illustrates the ablation for threat actor extraction of structured CTI information extraction tools according to embodiments of the present invention;

FIG. 17 illustrates the ablation for attack pattern extraction of structured CTI information extraction tools according to embodiments of the present invention;

FIG. 18 illustrates the performance for malware entity extraction of a structured CTI information extraction tool with heuristics according to one or more embodiments of the present invention compared to other tools;

FIG. 19 illustrates the performance for threat actor entity extraction of a structured CTI information extraction tool with heuristics according to one or more embodiments of the present invention compared to other tools; and

FIG. 20 illustrates the performance for relation extraction of a structured CTI information extraction tool according to one or more embodiments of the present application compared to other tools.

### DETAILED DESCRIPTION

Embodiments of the present invention provide machine learning systems and methods with improvements rooted in the field of computer processing, and in particular improvements to the field of machine learning. For example, in some variations, embodiments of the present invention might not require specific training of a model to accurately extract information, conserving computing resources and training time. Additionally, embodiments of the present invention can be adapted to the specific tasks of the security expert, increasing flexibility and usability. By improving the functioning of cyber security procedures, embodiments of the present invention also contribute to improved data security and privacy. Moreover, embodiments of the present invention can reduce the computing power required to implement cyber security procedures and programs and save computing resources, for example by improving the extraction of information for cyber security procedures. Embodiments of the present invention can also provide better performance than state-of-the-art models, improving accuracy, functioning of the computer processing, and use of computing resources. For example, by reducing the creation and/or storage of duplicate or multiple model specific datasets, computational resources (e.g., processing demands, memory demands) can be preserved.

Embodiments of the present invention can provide a system able to extract relevant information from cyber security reports with minimal human intervention by using Large Language Models (LLMs).

Given the relevance of CTI, despite the limited resources, security analysts invest a significant amount of time to manually process sources of CTI to structure the information in a standard format. In fact, the effort is sufficiently large that companies can form organizations to share the structured CTI and the cost of producing it. For instance, the cyber threat alliance (CTA) provides a platform to share CTI among members in the form of STIX bundles, and counts over thirty large companies among its members, such as CISCO, MCAFEE, SYMANTEC, SOPHOS, FORTINET and others. To aid this activity, the security community has been actively researching ways to automate the process of extracting information from unstructured CTI sources, which led to the development of several methods and tools.

While these solutions contribute to reduce the analyst load, their focus has been historically limited to the extraction of IoCs, which are relatively easy to identify with pattern matching methods (e.g., regular expressions). Only recently, the advances in natural language processing (NLP) using deep learning have enabled the development of methods that can extract more complex information (e.g., threat actor, malware, target, attack pattern). Nonetheless, the performance of these solutions is still limited. One of the problems is the way these machine learning solutions operate: they often specialize a general NLP machine learning model, fine-tuning it for the cybersecurity domain. Fine-tuning happens by means of providing the machine learning models with a training dataset, built by manually labeling a large number of reports.

However, these AI models may be specifically designed to perform tasks such as named entity recognition (NER), which are close to the needs of a security analyst and yet crucially different. Indeed, they might not take into account the relevance of the extracted information. For instance, a report describing the use of a new malware might mention other known malwares in a general introductory section or because they have been used in similar attacks in the past. Although these mentions are irrelevant to the current attack described in the report, a regular NER model can still extract and categorize them as malware. However, a security analyst compiling a structured CTI report would ignore such irrelevant mentions when extracting information about the attack. That is, generating a structured CTI report can require extracting only the relevant named entities (e.g., malware).

In a first aspect, the present disclosure a computer-implemented method for extracting and mapping structured information to a data model. Text data is obtained from one or more unstructured data sources. Rephrased text data is determined using a Large Language Model (LLM), a preprocessing prompt, and the text data. Extracted data is determined using the LLM, an extraction prompt, the data model, and the rephrased text data. The extracted data is mapped to the data model.

In a second aspect, the present disclosure provides the method according to the first aspect, further comprising: outputting the extracted data to a user interface for user review; receiving user input on the extracted data; determining a revised extraction prompt based on the user input; and determining further extracted data using the LLM, the revised extraction prompt, the data model, and the rephrased text data. The further extracted data is used as the extracted data that is mapped to the data model.

In a third aspect, the present disclosure provides the method according to the first or second aspect, wherein the one or more unstructured data sources include security reports, and the text data includes cyber threat intelligence (CTI) information related to a security incident.

In a fourth aspect, the present disclosure provides the method according to any of the first to third aspects, further comprising obtaining further text data from internet sources based on a determination that the text data does not contain sufficient information to be processed by the LLM, wherein determining the rephrased text is based on the text data and the further text data.

In a fifth aspect, the present disclosure provides the method according to any of the first to fourth aspects, wherein the text data and/or the further text data is obtained by parsing the one or more unstructured data sources and/or the internet sources based on entities defined by the data model.

In a sixth aspect, the present disclosure provides the method according to any of the first to fifth aspects, wherein determining the rephrased text data comprises: obtaining one or more text chunks from the text data based on an input capacity of the LLM; and inputting the preprocessing prompt and a first text chunk, of the one or more text chunks, into the LLM to obtain summarized rephrased text data for the first text chunk as the rephrased text data. The summarized rephrased text data comprises less text data than the first text chunk, and determining the extracted data is based on the summarized rephrased text data.

In a seventh aspect, the present disclosure provides the method according to any of the first to sixth aspects, further comprising inputting a further preprocessing prompt and a second text chunk, of the one or more text chunks, into the LLM to obtain second summarized rephrased text data for the second text chunk. The second summarized rephrased text data comprises less text data than the second text chunk, and determining the extracted data is further based on the second summarized rephrased text data.

In an eighth aspect, the present disclosure provides the method according to any of the first to seventh aspects, wherein determining the rephrased text data further comprises inputting the preprocessing prompt and the text data into the LLM to obtain expanded rephrased text for the text data. The expanded rephrased text comprises an expansion of the text data, and determining the extracted data is further based on the expanded rephrased text data.

In a ninth aspect, the present disclosure provides the method according to any of the first to eighth aspects, wherein the expansion of the text data comprises at least a portion of the text data and new text indicating a different description of information from the text data.

In a tenth aspect, the present disclosure provides the method according to any of the first to ninth aspects, further comprising: outputting the rephrased text data to a user interface for user review; receiving user input on the rephrased text data; determining a revised preprocessing prompt based on the user input; and determining further rephrased text data based on using the LLM, the revised preprocessing prompt, and the text data sources. The further rephrased text data is used as the rephrased text data in determining the extracted data.

In a eleventh aspect, the present disclosure provides the method according to any of the first to tenth aspects, further comprising obtaining entities of the data model using the extraction prompt and the LLM. The extraction prompt queries the LLM to extract the entities of the data model from the rephrased text data. The data model is a structured threat information expression (STIX) data model. Mapping the extracted data to the data model further comprises mapping the extracted entities to the data model and outputting the mapped data model to a user via a user interface.

In a twelfth aspect, the present disclosure provides the method according to any of the first to eleventh aspects, wherein: the text data includes cyber threat intelligence (CTI) information, and the entities include one or more of: malware, threat actor, target and vulnerability; or the text data includes medical records, and the entities include one or more of: patients, doctors, treatments, hospitals and drugs.

In a thirteenth aspect, the present disclosure provides the method according to any of the first to twelfth aspects further comprising: determining further rephrased text data using the LLM, a further preprocessing prompt different than the preprocessing prompt, and the text data sources, and/or determining further extracted data using the LLM, a further extraction prompt different from the extraction prompt, the data model, and the rephrased text data; and determining that the further rephrased text data is the same or substantially similar to the rephrased text data, or, that the further extracted data comprises a same extracted entity as the extracted data.

In a fourteenth aspect, the present disclosure provides a computer system for extracting and mapping structured information to a data model, the computer system comprising one or more hardware processors which, alone or in combination, are configured to provide for execution of the method according to any of the first to thirteenth aspects.

In a fifteenth aspect, the present disclosure provides a tangible, non-transitory computer-readable medium for extracting and mapping structured information to a data model, the computer system having instructions thereon which, upon being executed by one or more hardware processors, alone or in combination, provide for execution of the method according to any of the first to thirteenth aspects.

Embodiments of the present invention provide an adaptive system to automatically extract information from CTI reports written in free text and represent that information in a structured way by using LLMs. For example, embodiments of the present invention can use an LLM agent that makes (e.g., generates and/or provides) queries to an LLM by using prompt templates.

Once in a structure (e.g., STIX), aspects of suspicion, compromise and attribution from the CTI can be represented clearly with objects and descriptive relationships. STIX information can be visually represented for an analyst or stored (e.g., as JavaScript Object Notation (JSON)) to be quickly machine readable. However, before the information can be represented in a STIX structure, the STIX information may have to be extracted from the CTI text.

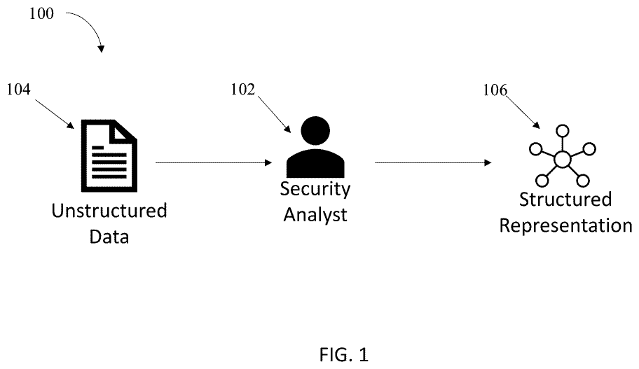

FIG. 1 illustrates an example of a manual pipeline 100 (e.g., manual extraction) for extracting structured CTI. In this process, one or more security analysts 102 read through a substantial volume of unstructured data 104 (e.g., CTI text reports), select the pertinent information, and then translate it into the desired structured representation 106, such as STIX.

As a result, the one or more security analysts 102 are responsible for generating the structured representation 106 from the unstructured data 104 (e.g., CTI text reports), and may be required to utilize their knowledge when selecting pertinent information, and expend time reading through the CTI text reports and translating the pertinent information into a structured representation 106.

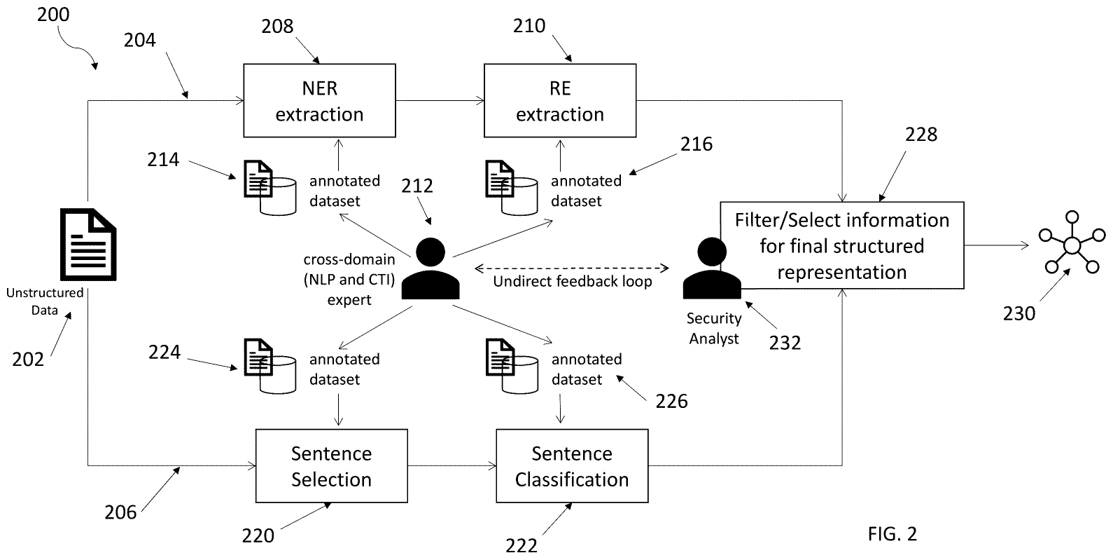

FIG. 2 illustrates an example embodiment of a pipeline 200 adopted for automated CTI extraction. Solutions of the pipeline 200 can encounter several issues. Automated methods for extracting CTI rely on various machine learning (ML) techniques, such as NLP. However, current automated methods can suffer from several critical limitations that significantly restrict their application.

First, the pipeline 200 can require the utilization of multiple pipelines to extract different types of information found in structured reports. In FIG. 2, two distinct pipelines are depicted: the entities and relations pipeline 204 for extracting entities and relations (e.g., malware, threat actors, and/or attack victims), and the attack pattern pipeline 206 for extracting and classifying attack patterns (e.g., sentences that describe the actions performed by the attacker according to a specific taxonomy) from the unstructured data 202. These pipelines 204, 206 consist of numerous ML components, and each may necessitate a specifically annotated dataset.

For example, the entities and relations pipeline 204 can include an NER model 208 for locating, classifying, and/or extracting named entities mentioned in the unstructured data 202 into pre-defined categories (e.g., person names, organizations, locations, time expressions). The entities and relations pipeline 204 can also include a relations model 210 for locating, classifying, and/or extracting relations between information and objects in the unstructured data 202 (e.g., the relations between named entities extracted by model 208). The model 208 can utilize annotated dataset 214 as an input from which to extract the named entities of the unstructured data 202, and the model 210 can utilize annotated dataset 216 as an input from which to extract the relations from the unstructured data 202. Moreover, the model 208 and the model 210 can each require separately annotated datasets.

Similarly, the attack pattern pipeline 206 can include a sentence selection model 220 for identifying and extracting sentences that contain the answer to a given question, and a sentence classification model 222 for categorizing the sentences into predefined groups. The model 220 can utilize annotated dataset 224 as an input from which to extract the named entities of the unstructured data 202, and the model 222 can utilize annotated dataset 226 as an input from which to extract the relations from the unstructured data 202. Moreover, the model 220 and the model 222 may each require separately annotated datasets.

An expert or analyst 212 (e.g., a cross-domain expert) may be required to generate the annotated dataset 214, the annotated dataset 216, the annotated dataset 224, and/or the annotated dataset 226 either separately or simultaneously, and possibly from different datasets of the unstructured data 202.

The datasets 214, 216, 224, and/or 226 can be generated explicitly for their respective task (e.g., the task of their respective model 208, 210, 220, 222). The datasets can align with the final structured format 230 used to represent the extracted information, and it can use the involvement of several cross-domain experts 212. The output 228 of these pipelines 204, 206 can still require verification, filtering, and selection by a human operator (e.g., analyst 232), as the components can be unable to comprehend the extracted information's relevance.

As an example of an excerpt of a cyber security report:

“We also found a YouTube account linked to the actor . . . . In another video instance, we observed the threat actor submit a LockBit 2.0 sample on Cuckoo sandbox and compare the results with another presumably LockBit 2.0 . . . . At the time of writing, we don't believe x4k is related to LockBit 2.0 activity . . . ”

While LockBit 2.0 is a malware, it is not related to the attack described in the example excerpt of the report. Previous methods could still extract and classify LockBit 2.0 as malware, possibly necessitating a human operator to read the text report and filter out irrelevant information.

Some previous methods can employ heuristics to automatically filter such cases, but they can often result in misclassification.

Finally, any modifications to the classification or data models used to represent the reports of the unstructured data 202 in the structured format 230 might not be able to be made directly by the analyst 232. Instead, modifications can require relabeling the datasets 214, 216, 224, and/or 226 used to train the pipeline component. For instance, changing the classification of LockBit from malware to ransomware could necessitate altering the associated labels. Consequently, the CTI analyst may be unable to directly adjust the pipelines 204, 206 to adapt it to the desired output 228.

Embodiments of the present invention can provide solutions to these limitations. First, embodiments of the present invention can utilize a single model for all components of the pipeline, eliminating the need for specifically annotated datasets or task-specific training. Instead, the single model can be instructed to perform the task without explicit training. Second, the reasoning capability of the single model can be leveraged to automatically filter and select relevant information. Unlike traditional methods that solely rely on classification, the single model's ability to reason can enable it to understand the context and relevance of extracted information.

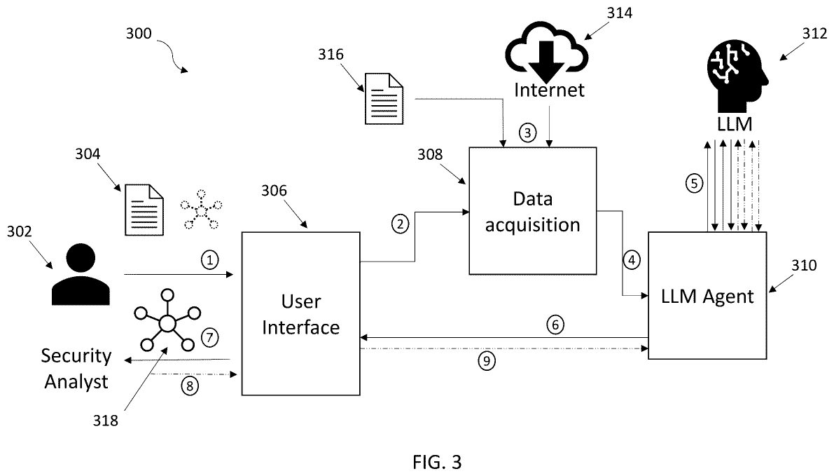

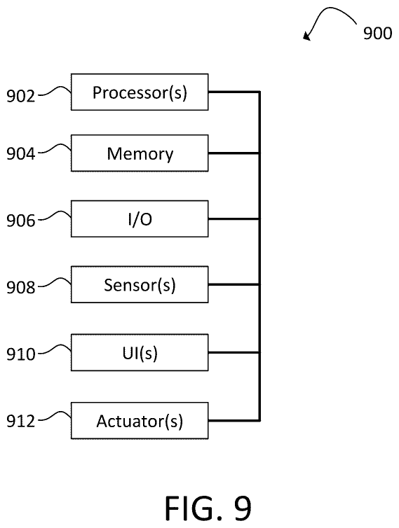

Third, embodiments of the present invention can eliminate the necessity of dedicated cross-domain experts to customize the pipeline for specific tasks. Unlike previous approaches that required domain-specific experts to program the pipeline, embodiments of the proposed model can allow any CTI analyst to directly interact with it. They can compare the model's output (e.g., FIGS. 3, 9) to what they would have generated manually (e.g., FIG. 1) and directly provide instructions to the model if needed. This flexibility empowers CTI analysts to adapt and fine-tune the pipeline according to their specific requirements without necessarily relying on external experts.

FIG. 3 describes a global system 300 according to one or more embodiments of the present invention. For instance, at a first step, the security expert and/or user 302 provides as inputs 304 to system 300 (e.g., the user interface 306 of the system 300) the report the user 302 wants to summarize and/or some terms indicating the topic the user 302 is interested in (e.g., the name of a malware) and the desired data model (e.g., STIX).

For example, in an embodiment of the present invention, the user interface 306 can receive the data and information from the reports without processing by the user 302. The user interface 306 can receive unstructured reports (e.g., HTML sources, text representations), for example in the original form the data was originally produced in, advantageously reducing the burden of the user 302 to structure the security reports themselves.

At a second step, the user interface 306 can send (e.g., provide and/or input) the information from inputs 304 to the data acquisition module 308 (e.g., a data acquisition device). The data acquisition module 308 can decide whether the information is enough for the LLM 312 to generate a response (e.g., an accurate or helpful response), or if the data acquisition module 308 is required to search for additional information on the internet 314 (e.g., to acquire and be parsed). This can be done, for example, by the data acquisition module 308 ensuring that the LLM agent 310 receives a textual report in contrast to a simple, short set of terms about a topic of interest to the user 302. For instance, when the user interface 306 has already provided a report, the data acquisition module 308 can decide that no additional material or information is needed. When the user interface 306 has specified (e.g., provided) simply some terms indicating a topic of interest (e.g., the name of a malware), the data acquisition module 308 can download additional information from the internet 314. This information can come from search engines or from links provided by the user interface 306 and/or a user 302 (e.g. websites of renowned organizations and institutions that publish cybersecurity reports on their website and provide search engines).

At a third step, the data acquisition module 308 parses the content 316 (e.g., the text of the report 304 and/or a representation of the text of the report 304) from the inputs 304 provided by the security expert or download 302. In some instances, the data acquisition module 308 is required to search on the internet 314 to supplement the parsed information. In such instances, the data acquisition module 308 then parses new information from the internet 314, either following links provided by the expert 302, or by searching (e.g., using search engines). To parse different sources, the data acquisition module 308 can have (e.g., include) different plugins specialized for specific websites/formats.

A plurality of plugins can be available to handle the individual formats of the unstructured reports (e.g., HTML sources, text representations). The data acquisition module 308 can use these plugins to obtain and parse the relevant information from the different sources of the input reports, and after parsing the different sources, the information provided by these different sources can be supplemented by further information acquired from the internet. For example, there are renowned organizations and institutions that publish cybersecurity reports on their website, and each website may have a different structure and format. The data acquisition module 308 could use a plug-in to extract, from the HTML page of the website, the human-readable plain text that would then be further processed (e.g., by LLM agent 310 and LLM 312). Data acquisition module 308 could also utilize a more refined plug-in designed for each source (e.g., source domain) that could remove unnecessary information from the page (e.g. the headers, footers and menus) which are common to all the reports from that website/domain, and which might not include the actual content of the report.

At a fourth step, the data acquisition module 308 can pass (e.g., transmit and/or send) the parsed information to the LLM agent 310, which in turn receives the parsed information and decides (e.g., determines) the queries that should be done (e.g., provided and/or input) to the LLM 312.

For example, in an embodiment of the present invention, the LLM agent 310 can form (e.g., determine and/or generate) a query (e.g., prompt) for the LLM 312 by selecting a portion (e.g., a chunk) of the parsed information (e.g., text data from the text data sources) that the LLM agent 310 received from the data acquisition module 308 that complies (e.g., matches or fits within) with the context window of the LLM 312, and a request to summarize the selected portion. The LLM agent 310 can supply this selected portion and prompt to the LLM 312, which can summarize the selected portion according to the prompt request (e.g., reduce the amount of text data in the selected portion to require less tokens for the LLM to process). The user 302 can provide instructions which can supplement (e.g., incorporate) relevant information into the summary generated by the LLM 312. When more than one selection from the parsed information is made and summarized, the summaries can be merged together and input to the LLM 312 (e.g., for extraction of entities by the LLM 312).

In an embodiment of the present invention, the LLM agent 310 can form a query (e.g., prompt) for the LLM 312 by selecting a portion (e.g., a chunk) of the parsed information (e.g., text data from the text data sources) that the LLM agent 310 received from the data acquisition module 308 that complies (e.g., matches or fits within) with the context window of the LLM 312, and a request to further describe the selected portion (e.g., identify key facts in the selected portion and/or drawing connections between information in the text). The LLM agent 310 can supply this selected portion and prompt to the LLM 312, which can describe the selected portion according to the prompt request. The user 302 can provide instructions which can supplement (e.g., incorporate) relevant information into the description generated by the LLM 312.

At a fifth step, the LLM agent 310 can perform (e.g., provide and/or input) several queries to the LLM 312 to preprocess and extract information. More information about the LLM agent 310 is provided below.

For example, in an embodiment of the present invention, the LLM agent 310 can input (e.g., provide and/or send) a desired data model including entities and relations to be identified, the previously generated summaries and/or descriptions, and/or the parsed information that the LLM agent 310 received from the data acquisition module 308, and a further prompt to the LLM 312. The further prompt can request that the LLM 312 extract entities from the provided input, including providing the entities in a specified format (e.g., for easy structuring into a desired ontology), and/or answer a specific question (e.g., “which malware is being used?”).

At a sixth step, the LLM agent 310 can receive the information output from the LLM 312, and parse the information received and format it in the desired data ontology (e.g., STIX).

At a seventh step, the user interface 306 returns the desired information 318 (e.g., the output of the LLM agent 310) to the security expert or user 302. For example, the expert 302 can view the ontology (e.g., the STIX bundle) generated by the LLM agent 310 and determine whether the STIX bundle accurately reflects the information (e.g., entities such as target, malware, pattern) of the inputs 304.

At an eighth step, the user 302 can provide feedback to the LLM agent 310 (e.g., the LLM agent 310 can receive feedback from the user 302). For example, after receiving the output of the LLM agent 310, the user 302 determines a change to the output of the LLM agent 310 and can provide that determined change to the user interface 306. The user interface 306 can then send that determined change to the LLM agent 310, and the LLM agent 310 can receive that determined change from the user interface 306 either directly or indirectly (e.g., via further processing components or entities).

At a ninth step, the LLM agent 310 can modify and/or add to the prompt templates (e.g. queries). For example, after receiving the feedback of the user 302, the LLM agent 310 can modify and/or add the prompt templates to those that are provided to the LLM 312, and these modifications and/or additions can be made based on the received feedback of the user 302.

In an embodiment of the present invention, a formatting component of the LLM agent 310 can map the information obtained from the LLM 312 and/or from the user 302 feedback into the desired ontology (e.g., STIX).

This process can be run repeatedly. For example, the process (e.g., steps one through nine) can start again based on the information 318 not being sufficiently good enough and/or successful for the security expert 302. In an embodiment, the user 302 can receive the information 318, evaluate the information 318, and provide feedback to the user interface 306. The user interface 306 can send the feedback to the LLM agent 310, directly or indirectly, and LLM agent 310 can modify and/or add to the prompt templates. The LLM agent 310 can then query the LLM 312, if necessary, using the modified or additional templates, and provide the output to the user interface 306, directly or indirectly. The user interface 306 can then provide the information to the expert 302. The expert 302 can again evaluate the information 318 and provide their feedback to the user interface 306, where the interface 306 will again provide the feedback to the LLM agent 310 for the modification and/or additions to the query templates. The LLM agent 310 can again query the LLM 312 using the modified and/or additional query templates, and provide the information 318 to the user interface 306 for the expert's 302 review.

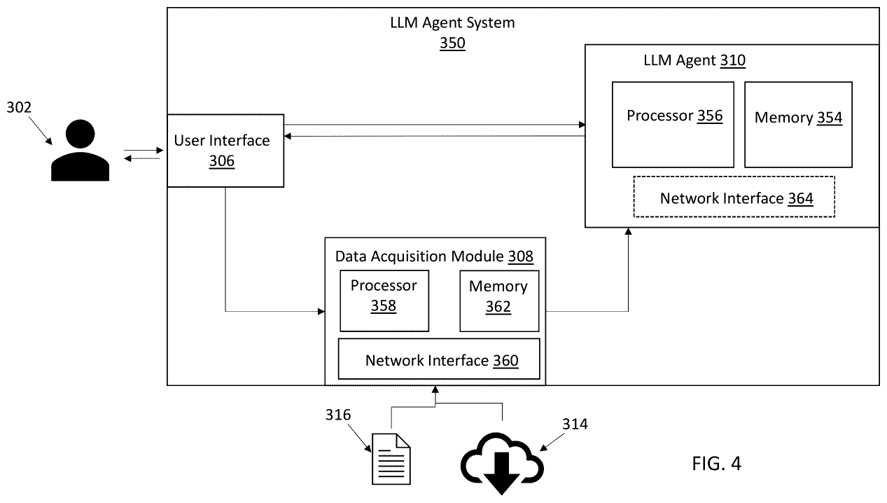

FIG. 4 is a simplified block diagram depicting an LLM agent system 350 in accordance with one or more embodiments of the present invention. For example, the LLM agent system 300 includes, but is not limited to, a security expert or user 302, a user interface 306, data acquisition module 308, and LLM agent 310. The user 302 can receive information from the user interface 306, and can evaluate information provided by the user interface 306 (e.g., the user 302 can determine if the information 318 is sufficient). The user 302 can then provide input to the user interface 306 (e.g., provide feedback on the information 318).

The user interface 306 can receive input from the user 302, and send this input to another component of the LLM agent system 300. For example, the user interface 306 can receive the inputs 304 or feedback on the information 318 from the user 302 and can send these to the LLM agent 310 and/or data acquisition module 308. For instance, if user interface 306 receives feedback on the information 318 from the user 302, the user interface 306 can send (e.g., provide) the feedback to the LLM agent 310 for further processing. If the user interface 306 receives the inputs 304 from the user 302, the user interface 306 can send (e.g., provide) the inputs 304 to the data acquisition module 308.

The user interface 306 can receive information from the LLM agent 310, and display the received information to the user 302. For example, the LLM agent 310 can provide an output (e.g., display the information received from the LLM agent 310) to the user 302. The user 302 can review the information, and accept or deny the information produced by LLM agent 310, e.g., can provide feedback or not provide feedback to the user interface 306. As mentioned above, when user 302 provides feedback on the information produced by the LLM agent 310, the user interface 306 can provide this feedback to the LLM agent 310.

The data acquisition module 308 can include a processor 358. The processor 358 can be any type of hardware and/or software logic, such as a central processing unit (CPU), RASPBERRY PI processor/logic, controller, and/or logic, that executes computer executable instructions for performing the functions, processes, and/or methods described herein. The processor can communicate with other components of the LLM agent system 350 (e.g., the user interface 306, LLM agent 310, network interface 360). The data acquisition module 308 can use processor 358 to receive the inputs 304 from the user interface 306. As described above, the data acquisition module 308 can evaluate (e.g. parse) the inputs 304 received from the user interface 306 (e.g., using processor 358 and evaluation processes of memory 362), and can use the processor 358 to forward (e.g., send and/or provide) the information from inputs 304 and/or the inputs themselves to the LLM agent 310. When the data acquisition module 308 uses the processor 358 to determine (e.g. decide) that the inputs 304 do not have sufficient and/or good enough information for the LLM agent 310, the data acquisition module 308 can use the processor 358 to access the internet 314 through network interface 360, and query sources on the internet 314. The processor 358 of the data acquisition module 308 can send (e.g., provide) queries to the internet 314, and can receive information from the internet 314 (e.g., in response to the provided query).

The data acquisition module 308 can include a memory 362. The memory 362 can include processes (e.g., programs and/or scripts) that are used by processor 358 to evaluate the inputs 304 provided by the user interface 306 to determine whether the inputs 304 contain sufficient information for the LLM agent 310 as described above. For example, the processor 358 can input the inputs 304 received from the user interface 306 into the processes of the memory 362 to determine whether enough information has been provided for the LLM agent 310 to form a prompt template for the LLM 312. These processes can be stored and maintained in memory 362 and/or updated or stored in memory. In some examples, the memory 362 can be and/or include a computer-usable or computer-readable medium such as, but not limited to, an electronic, magnetic, optical, electromagnetic, infrared, or semiconductor computer-readable medium. More specific examples (e.g., a non-exhaustive list) of the computer-readable medium can include the following: an electrical connection having one or more wires; a tangible medium such as a portable computer diskette, a hard disk, a time-dependent access memory (e.g., RAM), a ROM, an erasable programmable read-only memory (EPROM or Flash memory), a compact disc read-only memory (CD_ROM), or other tangible optical or magnetic storage device. The computer-readable medium can store computer-readable instructions/program code for carrying out aspects of the present application. For example, when executed by the processor 358, the computer-readable instructions/program code can carry out operations of the present application including determining whether sufficient information for the LLM agent 310 has been provided by user interface 306.

The LLM agent 310 can include processor 356. The processor 358 can be any type of hardware and/or software logic, such as a central processing unit (CPU), RASPBERRY PI processor/logic, controller, and/or logic, that executes computer executable instructions for performing the functions, processes, and/or methods described herein. The processor 356 can communicate with other components of the LLM agent system 350 (e.g., user interface 306, data acquisition module 308, and when present, network interface 364). The processor 356 of the LLM agent 310 can receive information from the user interface 306. For example, the processor 356 of the LLM agent 310 can receive the feedback that user 302 inputs (e.g., provides) to the user interface 306 by receiving the information that the user interface 306 sends. The LLM agent 310 can also use the processor 356 to provide (e.g., send) information to the user interface 306, which the user interface 306 can receive and display to the user 302. For example, the processor 356 of the LLM agent 310 can iteratively receive feedback (e.g., feedback on the information generated by the LLM agent 310) provided by the user 302 to the user interface 306, revise the generated information (e.g., revise the generated LLM prompt templates), and send the revised information to the user interface 306 for review by the user 302. This process can continue a set number of times (e.g., capped by a processing or predetermined threshold) and/or upon input by the user 302 (e.g., user 302 approving the input).

The LLM agent 310 can include a memory 354. The memory 354 can include processes (e.g., programs and/or scripts) that are used by processor 356 to evaluate the information received from the data acquisition module 308 to determine and/or generate a prompt template for the LLM 312 and/or for review by user 302 as described above. For example, the processor 356 can input the information received from the data acquisition module 308 into the processes of the memory 354 to determine and/or generate a prompt template for the LLM 312 and/or for review by user 302. These processes can be stored and maintained in memory 354 and/or updated or stored in memory. The LLM agent 310 can interact with one or more LLMs 312 that are provided (e.g., as a service through an application programming interface (API)). In some examples, the memory 354 can be and/or include a computer-usable or computer-readable medium such as, but not limited to, an electronic, magnetic, optical, electromagnetic, infrared, or semiconductor computer-readable medium. More specific examples (e.g., a non-exhaustive list) of the computer-readable medium can include the following: an electrical connection having one or more wires; a tangible medium such as a portable computer diskette, a hard disk, a time-dependent access memory (e.g., RAM), a ROM, an erasable programmable read-only memory (EPROM or Flash memory), a compact disc read-only memory (CD_ROM), or other tangible optical or magnetic storage device. The computer-readable medium can store computer-readable instructions/program code for carrying out aspects of the present application. For example, when executed by the processor 356, the computer-readable instructions/program code can carry out operations of the present application including determining and/or generating a prompt template for the LLM 312 and/or for review by user 302 as described above.

The LLM agent 310 can use processor 356 to send (e.g., provide and/or input) information (e.g., prompts) to one or more LLMs 312. In an embodiment of the present invention, the processor 356 of the LLM agent 310 can use network interface 364 (when present) to send the prompts to one or more LLMs 312 (e.g., an LLM 312 stored outside of memory 354). The processor 356 of the LLM agent 310 can also receive an output from the LLM 312, and in an embodiment of the present invention, the processor 356 of the LLM agent 310 can receive the outputs from the LLM 312 via the network interface 364 (when present).

LLMs are a type of artificial intelligence (AI) model that has been trained on massive amounts of natural language data to generate text that is indistinguishable from that produced by humans. These models can use deep learning techniques to learn the underlying patterns and structure of language, and can be fine-tuned to perform specific NLP tasks, such as language translation, question answering, or text completion.

LLMs can be characterized by their large number of parameters, which can range from tens of millions to hundreds of billions, and the sheer volume of data used to train them, which can include entire internet corpora or books. These models have revolutionized the field of NLP, enabling applications such as language translation, content generation, and conversational interfaces to reach unprecedented levels of accuracy and sophistication. They can be programmed by using prompts.

An LLM prompt is the initial input given to an LLM to generate a response. It can be a short sentence, a question, or a series of keywords that provide context for the LLM to generate a coherent and relevant text response. The prompt serves as a starting point for the model to generate text based on its learned patterns and structures from the training data.

For example, a prompt for a language translation LLM might be a sentence in one language that needs to be translated into another language. The LLM would use the prompt as a guide to generate a translation that accurately reflects the meaning and intent of the original sentence. Similarly, in a text completion task, the prompt could be a partial sentence or phrase that the LLM would use to generate a completed sentence that fits the given context.

The quality and specificity of the prompt can have a significant impact on the quality and relevance of the generated response. A well-crafted prompt can help the LLM generate a more accurate and appropriate response, while a vague or ambiguous prompt may result in a less coherent or relevant output.

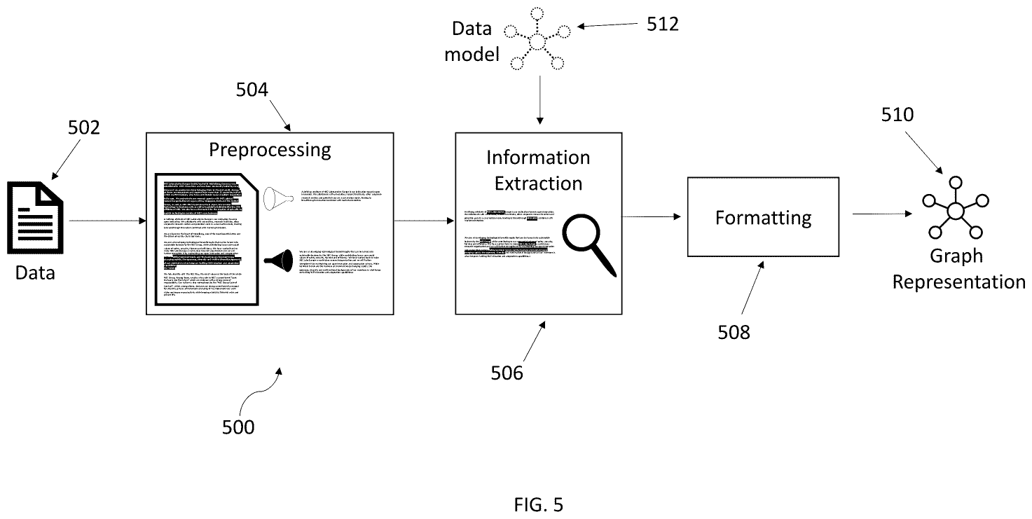

LLM agent (e.g., the LLM agent 310 shown in FIGS. 3 and 4): In an exemplary embodiment of the present invention, the LLM agent 500 is composed by three subsystems, as shown in FIG. 5. For instance, referring to FIGS. 3 and 4, in some embodiments, the LLM agent 500 can be the LLM agent 310. This LLM agent (e.g., 310 and/or 500) can be composed of three subsystems (e.g., the preprocessing component 504, the information extraction component 506, and the formatting component 508) that perform functionalities (e.g., processing, information extraction, and/or formatting).

The preprocessing component 504 is in charge of selecting relevant text from the unstructured input report (e.g., data 502). In some embodiments, it is capable of two different types of reasoning (e.g., summarization and filtering as well as expansion, which are described below).

Summarization and Filtering: The first type is used to filter and select relevant information explicitly included in the text. In order to filter out not relevant information and select relevant one, a larger context can be considered. In some embodiments, one limitation of LLMs can be their context window, as they can only process a limited amount of text at a time. To overcome this limitation, the preprocessing step and preprocessing component 504 can involve selecting the largest text chunk that fits within the LLM's input capacity. Subsequently, the text can be summarized, incorporating the relevant information based on the instructions provided by the CTI analyst in the prompt. For example, an LLM's input capacity can be a fixed value given by the specific LLM model chosen. The input capacity can be expressed in tokens, where a token is a single word or a part of a word. For instance, a LLM model might limit the total size of input plus output to 4,000 tokens (about 3,000-3,500 words), which can limit the kind of inputs that the LLM model can process. The input capacity selection of the LLM agent 310 would be in charge of splitting the input text in chunks based on the number of tokens corresponding to each chunk of text and the limits of the LLM model in terms of tokens.

One example of a summarizing and filtering prompt is provided below:

Write a concise summary of the following, include all the information regarding {filter,}:
{text}

### CONCISE SUMMARY:

The example embodiment above represents a prompt template used for summarization and filtering. All text chunks can undergo the same summarization and filtering process. Subsequently, they can be merged together into a single text, which is then passed through the extraction component 506 for the extraction step. This approach can help ensure that the generated text provides a comprehensive context for evaluating and extracting relevant information.

Expansion: the second type is employed to make explicit the pieces of information that are only implied in the text. In this case, the preprocessing step involves expanding on the concepts described in the text, potentially generating new text that provides a different description of the information contained in the original text. The amount of new text generated can be controlled to ensure it fits within the context window.

Attack pattern descriptions are an example of implicit information that it usually included in a CTI report. These descriptions outline the actions carried out by attackers or malware, and in CTI, it is common to process reports and classify these action according to a specific taxonomy.

The following is an example of a paragraph describing the use of attack pattern T1573 “Encrypted Channel” extracted from a report:

“The January 2022 version of PlugX malware utilizes RC4 encryption along with a hardcoded key that is built dynamically. For communications, the data is compressed then encrypted before sending to the command and control (C2) server and the same process in reverse is implemented for data received from the C2 server. Below shows the RC4 key “sV!e@T\#L\$PH\%” as it is being passed along with the encrypted data. The data is compressed and decompressed via LZNT1 and RtlDecompressBuffer. During the January 2022 campaigns, the delivered PlugX malware samples communicated with the C2 server 92.118.188 [.]78 over port 187.”

The use of an encrypted channel for communication with the command and control is not explicitly stated in the text.

The following prompt can be used to trigger the expansion reasoning on the text above.
Describe step by step the key facts in the following text:
{text}
KEY FACTS:

This is the corresponding output:

“The January 2022 version of PlugX malware uses RC4 encryption with a dynamically built key for communications with the command and control (C2) server.”

Summarized & filtered and expanded text can then be passed from the preprocessing component 504 as input to the extraction component 506 for the information extraction step.

The information extraction component 506 uses the output of preprocessing component 504. At this point, the resulting text can be fit in the context window of the LLM used. Again, using prompt templates, the LLM agent can query the LLM to obtain the different pieces of information required.

The LLM agent 500 (e.g., extraction component 506), supports several extraction methods, and it is possible to provide a list of information to extract:

From the following TEXT extract all {NER_str} entities. Classify the entities and output them according to the provided format.

```
  ==== Format ====
  MALWARE: <comma separated list> or None.
  THREAT_ACTOR: <comma separated list> or None.
or ask a direct question:
  Use the following pieces of context to answer the question at the end.
  {context}
  Question: Who/which is the target of the described attack?
```

In both cases it is possible to specify further filtering on the information to extract. For example, by limiting the list to a only a set of entities to extract o directly insert the filter in the question: “What malware was used in the attack? Do not consider backdoors as malware” or “Which organizations were victims of the attack? Include their countries of origin among the victims.”

After the extraction by extraction component 506, the information extraction modules (e.g., information extraction component 506) can perform an additional check-step, querying the LLM to confirm that the extracted information is present in the original text, and reporting an error in case of inconsistency.

Further, extraction component 506 can provide the extracted information to the formatting component 508. The formatting component 508 can map the information obtained to the ontology required. For example, the user can provide a desired data model 512 for which information should be extracted, and the desired data model 512 provided by the user might include entities according to the STIX standard. The formatting component 508 can then map the extracted information to the desired data model 512 to generate the graph representation 510.

In this case, the extracted information could be represented as a STIX bundle including in a graph format 510, which can include all the extracted entities (e.g., concrete instantiations of the types of entities requested by the user).

In one or more embodiments, a method for the extraction of structured CTI information from unstructured data sources such as cyber security reports can comprise the steps of:

1) Obtaining and parsing the relevant text data sources integrating input report (when available) and additional information from the Internet (when needed) (data acquisition block 308 in FIG. 3);
2) Definition of a pipeline of prompts to automatically process the CTI information by interacting with the LLM while taking into account the relevance of the information, neglecting what is not important for the task of the analyst;
a) Preprocessing prompts to select only relevant CTI information (malware, threat actor, target, attack patterns, etc.) and rephrase some text content to improve the performance of the following operations (preprocessing block 504 in FIG. 5);
b) Extraction prompts to extract the relevant CTI information (malware, threat actor, target, attack patterns, etc.) from the provided text based on the CTI data model specified by the user (information extraction block 506 in FIG. 5) (where “relevant” can be understood as being relevant to the end user (e.g., the CTI analyst) rather than being relevant in a general sense to the domain (e.g., any malware mentioned in the report)).
   3) Mapping the extracted information to the desired data model, e.g., ontology (formatting block 508 in FIG. 5). For example, the STIX ontology defines entities such as malware, threat actor, attack pattern and vulnerability.
   4) Optional refinement of information preprocessing and extraction steps based on user feedback.

Embodiments of the present invention can provide many advantages. For example, a preprocessing step and specific prompts can be used to reason about the context of the information included in the text for the task of extracting CTI information. The preprocessing step improves the performance of subsequent step (e.g., information extraction). This step can be used to:
a. Summarization and filtering: reason about the broader context in which the information is included (all the text report), and select what is relevant and what is not according to the received instructions
b. Expansion: reason about detailed steps implicitly included in an attack description, and generate a new/additional description of the explicit steps needed to perform the attack.

In some embodiments of the present invention, prompts can be used to directly specify which pieces of information to extract from CTI reports, to extract them, and/or finally to verify the correct extraction.

In some embodiments of the present invention, a CTI analyst can be allowed to be directly included in the feedback loop by having a system that produce an output that matches what is manually produced and it is programmable by giving simple instructions.

Embodiments of the present invention advantageously do not require specific training of the model, and can be adapted to the specific tasks of the security expert, thereby providing better performance than existing technology, and also saving training time and computational resources.

Embodiments of the present invention may also be applied in the field of medicine and health care (e.g., being applied to medical reports). For example, many steps of the pipeline (e.g. filtering or expansion) are applicable to other domains. For instance, by tailoring and/or adapting the prompts utilized by the LLM agent 310 and processed by the LLM 312 to the desired task and type of source documents (e.g., medical reports), embodiments of the present invention could provide an AI tool to assist those in the fields of medicine and health care. For example, medical-related documents may include important information in the images, but in other cases input documents might include text only, and in some cases may include both image and text information, and the expert 302, user interface 306, data acquisition module 308, LLM agent 310, and LLM 312 can all be adapted to process and extract the relevant image and/or text information from these reports depending on the relevant information and final task. Thus, as used herein, a “report” can refer to the source documents, which can include text and/or images, and an “incident” refers to an event or entity of interest in the relevant domain.

Referring to FIG. 9, a processing system 900 can include one or more processors 902, memory 904, one or more input/output devices 906, one or more sensors 908, one or more user interfaces 910, and one or more actuators 912. Processing system 900 can be representative of each computing system disclosed herein.

Processors 902 can include one or more distinct processors, each having one or more cores. Each of the distinct processors can have the same or different structure. Processors 902 can include one or more central processing units (CPUs), one or more graphics processing units (GPUs), circuitry (e.g., application specific integrated circuits (ASICs)), digital signal processors (DSPs), and the like. Processors 902 can be mounted to a common substrate or to multiple different substrates.

Processors 902 are configured to perform a certain function, method, or operation (e.g., are configured to provide for performance of a function, method, or operation) at least when one of the one or more of the distinct processors is capable of performing operations embodying the function, method, or operation. Processors 902 can perform operations embodying the function, method, or operation by, for example, executing code (e.g., interpreting scripts) stored on memory 904 and/or trafficking data through one or more ASICs. Processors 902, and thus processing system 900, can be configured to perform, automatically, any and all functions, methods, and operations disclosed herein. Therefore, processing system 900 can be configured to implement any of (e.g., all of) the protocols, devices, mechanisms, systems, and methods described herein.

For example, when the present disclosure states that a method or device performs task “X” (or that task “X” is performed), such a statement should be understood to disclose that processing system 900 can be configured to perform task “X”. Processing system 900 is configured to perform a function, method, or operation at least when processors 902 are configured to do the same.

Memory 904 can include volatile memory, non-volatile memory, and any other medium capable of storing data. Each of the volatile memory, non-volatile memory, and any other type of memory can include multiple different memory devices, located at multiple distinct locations and each having a different structure. Memory 904 can include remotely hosted (e.g., cloud) storage.

Examples of memory 904 include a non-transitory computer-readable media such as RAM, ROM, flash memory, EEPROM, any kind of optical storage disk such as a DVD, a Blu-Ray® disc, magnetic storage, holographic storage, a HDD, a SSD, any medium that can be used to store program code in the form of instructions or data structures, and the like. Any and all of the methods, functions, and operations described herein can be fully embodied in the form of tangible and/or non-transitory machine-readable code (e.g., interpretable scripts) saved in memory 904.

Input-output devices 906 can include any component for trafficking data such as ports, antennas (e.g., transceivers), printed conductive paths, and the like. Input-output devices 906 can enable wired communication via USB®, DisplayPort®, HDMI®, Ethernet, and the like. Input-output devices 906 can enable electronic, optical, magnetic, and holographic, communication with suitable memory 906. Input-output devices 906 can enable wireless communication via WiFi®, Bluetooth®, cellular (e.g., LTE®, CDMA®, GSM®, WiMax®, NFC®), GPS, and the like. Input-output devices 906 can include wired and/or wireless communication pathways.

Sensors 908 can capture physical measurements of environment and report the same to processors 902. User interface 910 can include displays, physical buttons, speakers, microphones, keyboards, and the like. Actuators 912 can enable processors 902 to control mechanical forces.

Processing system 900 can be distributed. For example, some components of processing system 900 can reside in a remote hosted network service (e.g., a cloud computing environment) while other components of processing system 900 can reside in a local computing system. Processing system 900 can have a modular design where certain modules include a plurality of the features/functions shown in FIG. 9. For example, I/O modules can include volatile memory and one or more processors. As another example, individual processor modules can include read-only-memory and/or local caches.

In the following, further background and description of exemplary embodiments of the present invention, which may overlap with some of the information provided above, are provided in further detail. To the extent the terminology used to describe the following embodiments may differ from the terminology used to describe the preceding embodiments, a person having skill in the art would understand that certain terms correspond to one another in the different embodiments. Features described below can be combined with features described above in various embodiments.

CTI plays a crucial role in assessing risks and enhancing security for organizations. However, the process of extracting relevant information from unstructured text sources can be expensive and time-consuming. Empirical experience shows that existing tools for automated structured CTI extraction have performance limitations. Furthermore, the community currently lacks a common benchmark to quantitatively assess their performance.

It has been recognized in the present invention that these gaps can be filled by providing a new large open benchmark dataset and an embodiment of the present invention referred to as ‘aCTIon,’ a structured CTI information extraction tool. The dataset includes 204 real-world publicly available reports and their corresponding structured CTI information in STIX format. The dataset was curated involving three independent groups of CTI analysts working over the course of several months; this dataset is two orders of magnitude larger than previously released open source datasets. aCTIon was then designed, leveraging recently introduced LLMs (e.g., Generating Pre-training Transformer 3.5 (GPT3.5)) in the context of two custom information extraction pipelines. aCTIon is compared with 10 solutions presented in previous work, for which implementations were provided when open-source implementations were lacking.

aCTIon outperforms previous work for structured CTI extraction with an improvement of the F1-score from 10% points to 50% points across all tasks.

CTI provides security operators with the information they need to protect against cyber threats and react to attacks. When structured in a standard format, such as STIX, CTI can be used with automated tools and for efficient search and analysis. However, while many sources of CTI are structured and contain IoCs, such as block lists of internet protocol (IP) addresses and malware signatures, most CTI data is usually presented in an unstructured format, e.g., text reports and articles. This form of CTI proves to be helpful to security operators, since it typically includes information about the attackers (threat actors) and victims (targets), and how the attack is performed: tools (malwares) and attack patterns. This is the information that typically enables threat hunting activities.

Given the relevance of CTI, despite the limited resources, security analysts can invest a significant amount of time to manually process sources of CTI to structure the information in a standard format. In fact, the effort is sufficiently large that companies can form organizations to share the structured CTI and the cost of producing it. For instance, the CTA provides a platform to share CTI among members in the form of STIX bundles, and counts over thirty large companies among its members, such as CISCO, MCAFEE, SYMANTEC, SOPHOS, FORTINET and others.

To aid this activity, the security community has been actively researching ways to automate the process of extracting information from unstructured CTI sources, which led to the development of several methods and tools. While these solutions contribute to reduce the analyst load, their focus has been historically limited to the extraction of IoCs, which are relatively easy to identify with pattern matching methods (e.g., regular expressions). Only recently have the advances in NLP using deep learning enabled the development of methods that can extract more complex information (e.g., threat actor, malware, target, attack pattern). Nonetheless, the performance of these solutions is still limited.

It has been realized in an embodiment of the present invention that one of the problems may be the way these ML solutions operate: they often specialize a general NLP machine learning model, fine-tuning it for the cybersecurity domain. Fine-tuning happens by means of providing the models with a training dataset, built by manually labeling a large number of reports. However, these AI models are specifically designed to perform tasks such as NER, which are close to the needs of a security analyst and yet different. For instance, a report describing the use of a new malware might mention other known malwares in a general introductory section. These malwares would be extracted by a regular NER model, whereas a security analyst would ignore them when compiling the structured report. That is, generating a structured CTI report requires extracting only the relevant named entities. To make things worse, the security community currently lacks a large labeled dataset that could work as benchmark to evaluate these tools. Indeed, the current state-of-the-art is mostly evaluated using metrics belonging to the NLP domain, which essentially evaluate a subtask in place of the end-to-end task performed by the security analyst.

Embodiments of the present invention can provide a means to evaluate existing and future tools for structured CTI information extraction, and a solution to improve on the state-of-the-art.

First, a labeled dataset including 204 reports collected from renowned sources of CTI, and their corresponding STIX bundles is contributed. The reports vary in content and length, containing 2133 words on average and up to 6446. Trained security analysts examined the reports over the course of several months to define the corresponding STIX bundles. This process required, among other things, to classify attack patterns using the MITRE ATT&CK matrix (tactics, techniques, and procedures), which includes more than 340 detailed entries. The analyst needs to know these techniques and understand if the case described in the report fits any of them, to perform correct classification.

Second, the results of 10 recent works are replicated, providing implementations when these were not available, and use a benchmark dataset to evaluate them. The evaluation shows that the improvement in NLP technology had an impact on the performance of the tools, which got much better over time and since the inclusion of NLP technology such as transformer neural networks (e.g., BERT). At the same time, the evaluation shows there are gaps, with the best performing tools achieving on average across all reports less than 50% in recall/precision, for any specific type of information extracted (e.g., malware, threat actor, target and attack pattern).

Finally, inspired by recent advances in LLMs such as GPT3, a new solution from an embodiment of the present invention, aCTIon, is contributed, using LLM's zero-shot prompting and in context learning capabilities. The approach addresses some of the main shortcomings and constraints of the current generation of LLMs, namely hallucinations and small context windows, in the constrained setting of a use case. To do so, a novel two-step LLM querying procedure is introduced over the recent approaches used in the design of LLM-based generative AI Agents. In the first step, the input report is pre-processed to extract and condense information in a text that can fit the limits of the target LLM. In the second step, extraction and self-verification prompts for the LLM are defined, which finally selects and classifies the extracted information. There are several alternative variations of the above general approach, and the embodiment of aCTIon can outperform the state-of-the-art by increasing the F1-score by 15-50% points for malware, threat actor and target entities extraction, and by about 10% points for attack pattern extraction.

This improvement over the past work went beyond expectations, and embodiments of aCTIon were immediately tested internally for daily CTI operations. A manual inspection of the results was performed to investigate failure cases. The manual analysis and experience speculated that aCTIon's performance is in line with the performance of a trained security analyst. There is an inherent semantic uncertainty when structuring CTI information (e.g., what is considered a relevant entity by an analyst may differ). However, this finding might not be able to be confirmed without a different team of security analysts to relabel the dataset and measure their agreement with the already provided labels. To foster further research in this area, the dataset, including reports and labels, is released.

Life and pain of a CTI analyst: a large amount of valuable CTI is shared in unstructured formats, including open-source intelligence (OSINT), social media, the dark web, industry reports, news articles, government intelligence reports, and incident response reports.

Using unstructured CTI is challenging as it cannot be efficiently stored, classified, and analyzed, which may cause security experts to thoroughly read and comprehend lengthy reports. Consequently, one of the tasks of a security analyst is to convert the vast amount of unstructured CTI information in a format that simplifies its further analysis and usage.

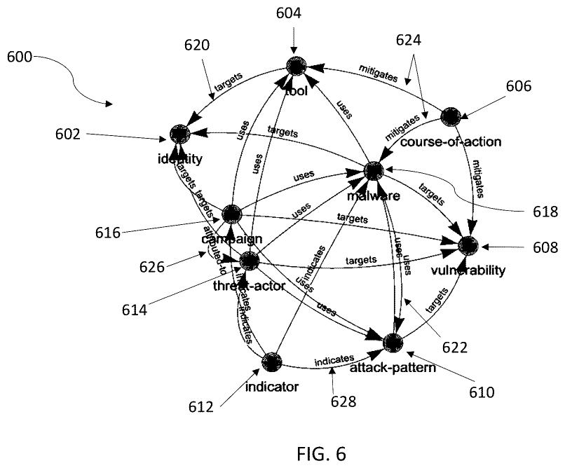

STIX is an example of a standard format for CTI widely adopted by the industry. In STIX, each report (a bundle in STIX terminology) is a knowledge graph, e.g., a set of nodes and relations that describe a security incident or a relevant event. The STIX ontology describes all the entity and relation types, and FIG. 6 shows a subset of the STIX ontology, including all entities and relations contained at least once in the dataset. The ontology includes several conceptual entities, such as threat actor, malware, vulnerability, attack pattern, and indicator. Furthermore, it also defines relations between these entities, such as uses and targets, to capture their interactions.

An example of a report is provided, and how analysts extract structured STIX bundles from text reports is introduced. The most common information extracted by analysts is:
Who performed the attack (e.g., threat actor);
Against whom it was performed (e.g., identity pointed by a targets relation); and
How the attack was performed (e.g., malware and attack pattern).

This subset of the STIX's ontology is the most common set of information pieces contained in reports. For instance, in the dataset 75% and 54% of reports include at least a malware and threat actor entity, respectively. Furthermore, and possibly more importantly for a fair evaluation of the state-of-the-art, this subset is consistently supported across existing tools and previous work, which allows us to run an extensive comparison among solutions.

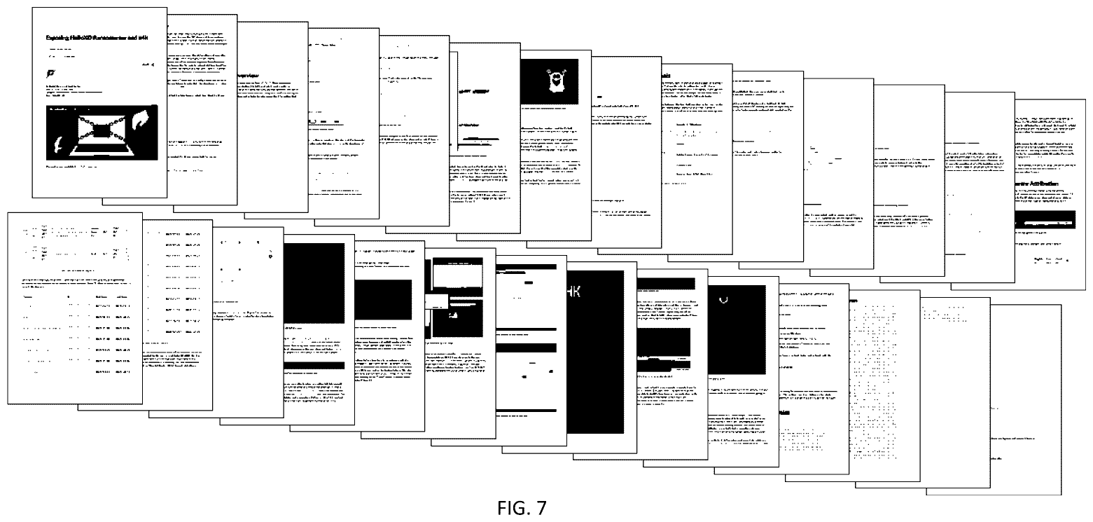

Structured CTI Extraction: The technical blogpost from Palo Alto Networks, presented at a glance in FIG. 7, illustrates a structured CTI extraction task. The report describes the attribution of the ransomware HelloXD to a threat actor known as x4k, including the set of tactics, techniques and procedures associated with them. The report is about 3.7K words long, includes 24 different images, 3 tables with different information and a list of Indicator of Compromise (in a dedicated section at the end of the report). It first explains the functionality of the HelloXD ransomware, and then it uncovers several clues that link the ransomware to the threat actor x4k. Furthermore, the post provides a description of the threat actor's modus operandi and infrastructure.

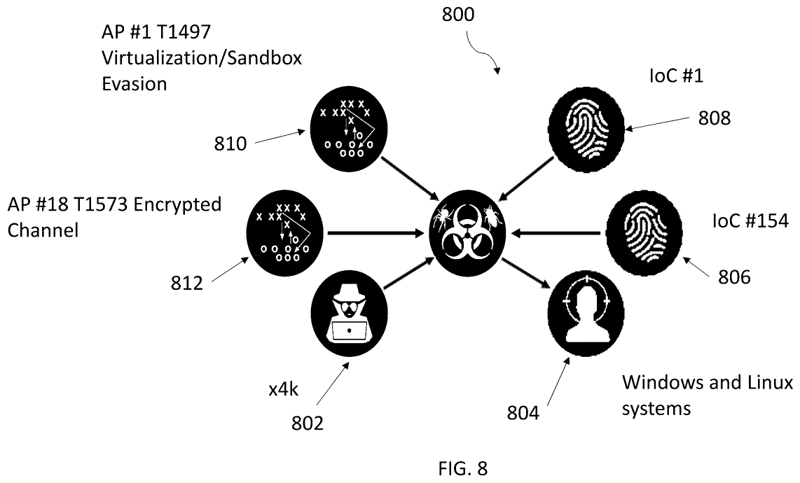

Structured CTI extraction is performed to define a STIX bundle 800 representing the report, like the one depicted in FIG. 8. The bundle includes the threat actor 802 (x4k), the malware (HelloXD), and a set of attack pattern entities (e.g., attack pattern 810, 812) describing the various targets (e.g., WINDOWS and LINUX systems 804), tactics, techniques and procedures, plus the indicators (e.g., IoC #1 808, IoC #154 806) extracted from the last section of the report.

Defining this bundle is a time consuming task that requires security knowledge and experience. It can take 5-10 hours to extract a structured STIX bundle out of a report. For instance, in the authors mention that labelling 133 reports required 3 full time annotators over 5 months. Likewise, the annotation of the 204 reports in the dataset took a team of CTI analysts several months.

As explained above, FIG. 7 illustrates an example of the collection of materials of a report published by PALO ALTO NETWORKS. While IoCs are easy to extract being collected at the end of the report, extracting threat actor, malware, attack pattern and the other STIX's entities can require security experts to perform manual analysis. FIG. 8 illustrates a STIX bundle describing the report from FIG. 7.

To understand why this task is time consuming, and why it is hard to automate, an embodiment of how analysts identify the relevant entities and the case of the sample report is described below.

Malware, threat actor, and identity first: the analyst can start by identifying malwares, threat actors and identities. While this might at first glance appear as a simple task, security reports tend to be semantically complex, including issues such as: information represented ambiguously, e.g., threat actor and malware called with the same name; the use of aliases to describe the same entity, e.g., a malware called with multiple name variants; uncertain attribution of attacks, e.g., the report might certainly attribute some attacks to a threat actor, and might only mention other attacks as potentially related to the threat actor, but not confirmed. These are just a few examples of the nuances that can make processing time consuming, and automation difficult.

Example: the sample report specifically discusses the HelloXD ransomware. Yet, it is not uncommon for a malware to be deployed and utilized in conjunction with other malicious software. Thus, understanding what malicious software is effectively described in the attack assists the understanding of which malware nodes should be included in the STIX bundle. In the report, there are mentions of two other malwares beyond HelloXD: LockBit 2.0 and Babuk/Babyk. However, these malwares should not be included in the bundle. For instance, LockBit 2.0 is mentioned because it leverages the same communication means used by HelloXD (see quote below). Nonetheless, LockBit 2.0 is not directly connected to HelloXD infections, and therefore it should not be included.

“The ransom note also instructs victims to download Tox and provides a Tox Chat ID to reach the threat actor. Tox is a peer-to-peer instant messaging protocol that offers end-to-end encryption and has been observed being used by other ransomware groups for negotiations. For example, LockBit 2.0 leverages Tox Chat for threat actor communications.

Attack pattern second: the analyst can identify the attack patterns, e.g., descriptions of tactics, techniques and procedures, and attribute them to the entities identified in the previous step. This introduces additional challenges: attack patterns are behaviors typically described throughout several paragraphs of the report, and they are collected and classified in standard taxonomies such as the MITRE ATT&CK Matrix. The MITRE ATT&CK Matrix includes more than 340 detailed techniques and 450 sub-techniques. The analyst can refer to them when building the bundle, identifying which of the classified techniques are contained in the text report. That is, this tasks might require both understanding of the report and extensive specialized domain knowledge.

Example: the sample report includes 18 different attack patterns. For instance, the quote provided earlier is associated to the technique T15732, which states:

“Adversaries may employ a known encryption algorithm to conceal command and control traffic rather than relying on any inherent protections provided by a communication protocol . . . ”

Relevance throughout the process: the analyst can take decisions about what to leave out of the bundle, using their experience. This decision usually includes considerations about the level of confidence and details of the information described in the report. For instance, the sample report describes other activities related to the threat actor x4k, such as the deployment of Cobalt Strike Beacon and the development of custom Kali Linux distributions. The analyst must determine whether to include this information or not. In this example, these other activities are just mentioned, but they might not be related to the main topic of the report (nor contain enough details), and therefore they should not be included.

The quest for automation: given the complexity of the task, several solutions have been proposed over time to help automate structured CTI extraction. Previous work addressed either individual problems, such as attack patterns extraction, or the automation of the entire task. Nonetheless, all the previous tools can still require significant manual work in practice. The empirical work of a team of CTI analysts supports this claim, and the evaluations disclosed herein confirm this.

One of the reasons for which existing solutions do not meet the expectations of CTI analysts can be due to the lack of a benchmark that correctly represents the structured CTI extraction task, with its nuances and complexities. In particular, since previous work heavily relies on ML methods for NLP, it is quite common to resort to typical NLP evaluation approaches. However, NLP tasks are a conceptual subset of the end-to-end structured CTI extraction task, therefore, the majority of proposed benchmarks do not evaluate CTI-metrics.

To exemplify this issue, start with NER, e.g., the NLP task of automatically identifying and extracting relevant entities in a text. When evaluating an NER component, NLP-metrics can count how many times a word representing an entity is identified. For instance, if the malware HelloXD is mentioned and identified 10 times, it would be considered as 10 independent correct samples by a regular NER evaluation. This approach is referred to as word-level labeling. For the sake of simplicity of exposition the term “word-level” in place of the more appropriate “token-level” is used. However, for structured CTI extraction, an interest is to extract the malware entity, regardless of how many times it appears in the report. This can potentially lead to an overestimation of the method performance. More subtly, as seen with the example of the Lockbit 2.0 malware, some entities that would be correctly identified by an NER tool are not necessarily relevant for CTI information extraction task. However, such entities are typically counted as correct if the evaluation employs regular NLP metrics. The same issue applies to the more complex attack pattern extraction methods. Indeed, they are commonly evaluated on sentence classification tasks, which assess the method ability to recognize if a given sentence is an attack pattern and to assign it to the correct class. This approach is referred to as sentence-level labeling. However, such metrics do not fully capture the performance of the method in the light of the CTI-metrics. This would involve identifying all relevant attack patterns in a given report, and correctly attributing them to the relevant entities.

Table 1: Manually annotated reports. In some works, the annotated reports are a subset of a much larger dataset, whose size is reported in parenthesis. Numbers with a “*” refer to sentences rather than whole reports. (V) refers to datasets only partially released as open-source.

| | Entities & | | Attack | | CTI | |
|---|---|---|---|---|---|---|
| | relations | | patterns | | metrics | Public |
| SecIE | 133 | | 133 | | — | |
| CASIE | 1k | | — | | — | ✓ |
| ThreatKG | 141 | (149k) | 141 | (149k) | — | |
| LADDER | 150 | (12k) | 150 | (12k) | 5 | (✓) |

| SecBERT | — | 12.9k* | | 6 | ✓ |
|---|---|---|---|---|---|
| TRAM | — | 1.5k* | | — | ✓ |
| TTPDrill | — | 80 | (17k) | 80 | |
| AttacKG | — | 16 | (1.5k) | 16 | |

| | | | | |
|---|---|---|---|---|
| rcATT | — | 1.5k | — | ✓ |

Table 1 summarizes datasets from the literature, which are employed in the evaluation of the respective previous works. The table considers separately the extraction of the attack pattern entity, given its more complex nature compared to other entities (e.g., malware, threat actor, identity). Some of these works use remarkably large datasets to evaluate the information extracted in terms of NLP performance (e.g., number of extracted entities). Unfortunately, they often include much smaller data subsets to validate the methods in respect to CTI-metrics. One reason often mentioned for the small size of such data subsets is the inherent cost of performing manual annotation by expert CTI analysts.

NLP-metrics SecIE, ThreatKG and LADDER, all adopt datasets with word-level or sentence-level labeling. Similarly, CASIE provides a large word-level labeled dataset, and does not cover attack patterns. TRAM and rcATT provide attack pattern datasets that are sentence-level labeled.

CTI-metrics: a few works provide labeled data that correctly capture CTI-metrics. TTPDrill and AttacKG perform the manual labeling of 80 and 16 reports, respectively, on a reports-basis, but unfortunately do not share them. Also, they cover only attack patterns extraction. SecBERT evaluates the performance on a large sentence-level dataset, but then provides only 6 reports with CTI-metrics. Similarly, as part of its evaluation LADDER also includes the attack pattern extraction task using CTI-metrics, but just on 5 reports (which are not publicly shared).

The dataset: the lack of an open and sufficiently large dataset focused on structured CTI extraction can hinder ability to evaluate existing solutions and to consistently improve on the state-of-the-art. To fill this gap an embodiment of the present invention created a new large dataset including 204 reports and their corresponding STIX bundles, as extracted by an expert team of CTI analysts. The dataset represents real-world CTI data, as processed by security experts, and therefore exclusively focuses on CTI-metrics. The dataset has been made publicly accessible.

Information about the dataset creation methodology is disclosed herein, and introduces high-level statistics about the data.

Methodology: the organization includes a dedicated team of CTI analysts whose main task is to perform structured CTI extraction from publicly available sources of CTI. Their expertise is leveraged and a methodology is established to collect a set of 204 unstructured reports, and their corresponding extracted STIX bundles. Structured CTI extraction is manually performed by multiple CTI analysts, organized in three independent groups with different responsibilities, as outlined next:

Group A selects unstructured reports or sources of information for structured CTI extraction. The selection is based on the analyst's expertise, and is often informed by both observed global trends and specific internal requirements. For instance, reports focused on threats that are likely to affect the organization and its clients.

Group B performs a first pass of structured CTI extraction from the selected sources. This group makes large use of existing tools to simplify and automate information extraction, for instance tools like TRAM. Notice that this set of tools overlaps with those mentioned in Table 1 and that are later assessed in an evaluation. The actual structured CTI extraction happens in multiple processing steps. First, the report is processed with automated parsers, e.g., to extract text from a web source. Second, the retrieved text is segmented into groups of sentences. These sentences are then manually analyzed by the analyst, who might further split, join, or delete sentences to properly capture concepts and/or remove noise. The final result is a set of paragraphs. Third, the analyst applies automated tools to do a pre-labeling of the relevant named entities, and then performs a manual analysis on each single paragraph flagging the entities that are considered correct, and potentially adding entities that were not detected. Fourth, a second analysis is performed on the same set of paragraphs, this time to extract attack patterns. Also in this case, the analyst uses tools like TRAM to perform a pre-labeling and identification of attack patterns, and then performs a manual analysis to flag correct labels and add missing ones. Finally, the analyst uses a visual STIX bundle editor (an internally built GUI) to verify the bundle and check any correct attribution, e.g., the definition of relations among entities.

Group C performs an independent review of the work performed by Group B. The review includes manual inspection of the single steps performed by Group B, with the goal of accepting or rejecting the extracted STIX bundle.

The above process is further helped by a software infrastructure that the organization developed specifically to case the manual structured CTI extraction tasks. Analysts connect to a web application and are provided with a convenient pre-established pipeline of tools. Furthermore, the web application keeps track of their interactions and role (e.g., analyst vs reviewer), and additionally tracks the time spent for each sub-step of the process. This allows for an estimation of the time spent to perform structured CTI extraction on a report (excluding the work of Group A). For the dataset presented herein, an average of 4.5 h per report was observed, with the majority of the time spent by group B (about 3 h).

Using this methodology 204 reports and their corresponding STIX bundles were collected, creating the basis of the dataset. An additional manual processing step was then performed to ensure accuracy and completeness. First, only reports that were publicly available on the internet were selected, and the reports were checked to ensure that all the information in the STIX bundle is contained in the original report. This is a safety check to ensure that analysts did not include entities or relations that might have been inferred from their own experience. This step further ensured that no confidential information is shared within the dataset. The structured CTI extraction task puts analysts under heavy cognitive burden. A tired analyst might include information read from a similar source and not necessarily included in the processed report. Second, any spelling errors in the named entities of the STIX representation were verified and corrected. Since the names of malwares and threat actors can be complex, spelling errors may occur even after the review of Group C. For manual processing of the structured CTI this is not a big issue, since analysts can readily recognize the spelling errors. Nonetheless, for automated benchmarking these errors might introduce wrong results. Third, a list of synonyms for each named entity in the report was extracted. This was done because the same malware or threat actor may be referred to using different names in the same report. This information is not formally included in the STIX standard and may be included or expressed differently depending on the operator processing the report. However, it is fundamental for a correct evaluation, as synonymous references should be considered correct extractions.

Dataset summary: the resulting dataset comprises 204 STIX bundles, which collectively contain 36.1 k entities and 13.6 k relations. FIG. 6 presents the resulting STIX ontology 600 based on the dataset, including 9 unique entity types (e.g., identity 602, tool 604, course-of-action 606, vulnerability 608, attack-pattern 610, indicator 612, threat-action 614, campaign 616, and malware 618) and 5 unique relation types (e.g., targets 620, uses 622, mitigates 624, attributed to 626, indicates 628). FIG. 6 also shows the set of admissible types of relations between specific pairs of entity types.

TABLE 2
Dataset statistics by report. The last column shows the quota
of reports containing each entity type at least once.

| | min | avg | 75p | max | quota |
|---|---|---|---|---|---|
| words | 504 | 2133.6 | 2763.2 | 6446 | — |
| sentences | 11 | 86.3 | 110.2 | 358 | — |
| STIX objects | 13 | 177.1 | 217.5 | 1255 | — |
| STIX relations | 5 | 67.0 | 81.2 | 429 | — |
| malware | 0 | 0.9 | 1 | 5 | 75% |
| threat-actor | 0 | 0.6 | 1 | 2 | 54% |
| attack-pattern | 0 | 21.8 | 28 | 63 | 99% |
| identity | 1 | 1.7 | 2 | 5 | 100% |
| indicator | 1 | 41.9 | 52.2 | 395 | 100% |
| campaign | 0 | 0.6 | 1 | 4 | 55% |
| vulnerability | 0 | 0.5 | 0 | 11 | 21% |
| tool | 0 | 0.1 | 0 | 10 | 6% |
| course-of-action | 0 | 0.0 | 0 | 1 | 2% |
| uses | 1 | 23.6 | 30 | 64 | 100% |
| indicates | 1 | 41.9 | 52.2 | 395 | 100% |
| targets | 0 | 1.2 | 1 | 12 | 77% |
| attributed-to | 0 | 0.3 | 1 | 2 | 26% |
| mitigates | 0 | 0.0 | 0 | 2 | 2% |

Table 2 reports the dataset statistics by report and is split in four sections: words and sentences counters, total number of STIX objects and relations, number of STIX objects by type and number of STIX relations by type. For the last two sections, the last column provides the quota of reports that includes at least once a given type of entity. For example, 75% of the bundles include a malware entity, and 54% include a threat actor. This highlights the prevalence of these critical components within the dataset, underscoring their importance in the context of CTI extraction and analysis.

It is time for aCTIon: The introduced dataset allows for quantifying the performance of existing tools for structured CTI extraction. Those results are presented in detail later, but anticipate here that the empirical experience is confirmed: the performance of previous work on structured CTI extraction is still limited. For example, the best performing tools in the state-of-the-art provide at most 60% F1-score when extracting entities such as threat actor or attack pattern.

Given the pressure to reduce the cost of structured CTI extraction in the organization and the limitations of the state-of-the-art, an embodiment of the present invention, referred to as aCTIon, was developed: a structured CTI extraction framework. The embodiments attempts to replace entirely the information extraction step from the task, e.g., the work of Group B, leaving only the bundle review step to CTI analysts.

aCTIon builds on the recent wave of powerful LLMs, therefore a short background about this technology is provided before detailing aCTIon's design goals and decisions.

LLMs primer: LLMs are a family of neural network models for text processing, generally based on transformer neural networks. Unlike past language models trained on task-specific labeled datasets, LLMs are trained using unsupervised learning on massive amount of data. While their training objective is to predict the next word, given an input prompt, the scale of the model combined with the massive amount of ingested data makes them capable of solving a number of previously unseen tasks and acquire emergent behaviors. For instance, LLMs are capable of translating from/to multiple languages, perform data parsing and extraction, classification, summarization, etc. More surprisingly, these emergent abilities include creative language generation, reasoning and problem-solving, and domain adaptation.

From the perspective of system builders, perhaps the most interesting emergent ability of LLMs is their in-context learning and instruction-following capabilities. That is, users can program the behavior of an LLM prompting it with specific natural language instructions. This can remove the need to collect specific training data on a per-task basis, and enables their flexible inclusion in system design. For instance, a prompt like “Summarize the following text” is sufficient to generate high-quality summaries.

While LLMs have great potential, they also have other considerations. First, their training can be expensive, and therefore they can be retrained with low frequency. This can makes the LLM unable to keep up to date with recent knowledge. Second, their prompt input and output sizes can be limited. The input of LLMs can be first tokenized, and then provided to the LLM. A token can be thought as a part of a word. For instance, a model might limit to 4 k tokens (about 3 k-3.5 k words) the total size of input plus output, which limits the kind of inputs that can be processed. Finally, LLMs might generate incorrect outputs, a phenomenon sometimes called hallucination. In such cases, the LLM generated answers might be imprecise, incorrect, or even completely made-up, despite appearing as a confident statement at first glance.

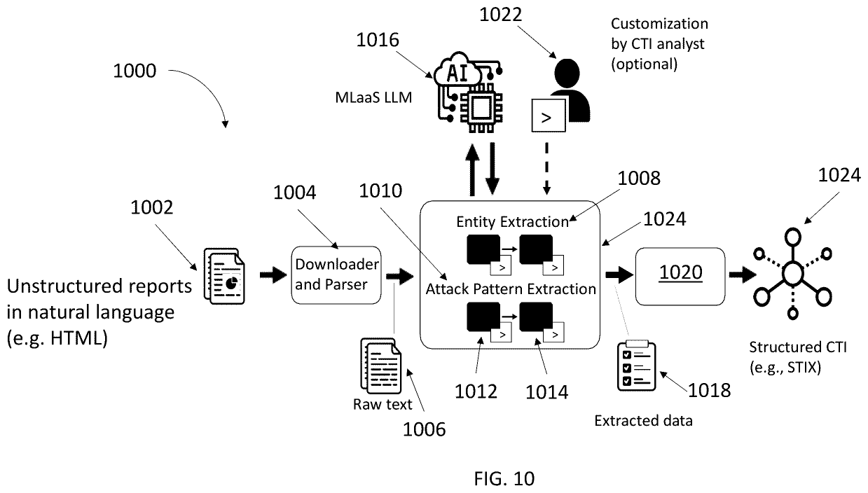

aCTIon-design: FIG. 10 depicts the overall architecture 1000 of embodiments of the present invention of the aCTIon framework as a high-level architecture, which can comprise three main components. Downloader and parser 1004 converts unstructured input reports 1002 in different formats, e.g., HTML, to text-only representations into different formats (e.g., raw text 1006). It includes plugins to handle the format of specific well-known CTI sources, as well as a fallback default mode if no plugin is available for the desired source. The second component 1006 is the core of the aCTIon framework and consists of two different pipelines: a pipeline 1008 extracts most of the entities and relations; a second pipeline 910 deals specifically with attack pattern extraction. Both pipelines 1008, 1010 implement a two-stage process and leverage an LLM at different stages. The two stages implement preprocessing (P) 1012, to select relevant text from the unstructured input report, and extraction (E) 1014, to select and classify the target entities.

The LLM 1016 can be provided as-a-service, through API access. While different providers are in principle possible (including self-hosting), aCTIon currently supports the entire GPT family from OpenAI. In an embodiment of the present invention, a focus on the GPT-3.5-turbo model is possible. When present, a CTI analyst 1022 can customize and revise the outputs of the LLM 1016 and/or the prompts for the LLM agent 1024.

Finally, data exporter 1020 parses the output (e.g., extracted data 1018) of the pipelines to generate the desired output format 1024, e.g., STIX bundles.

Design challenges and decisions: the aCTIon's two-stages pipelines can be designed to handle the two main challenges faced during the design phase. First, one concern was related to the handling of LLM's hallucinations, such as made-up malware names. To minimize the probability of such occurrences, the LLM can be used as a reasoner, rather than relying on its retrieval capability. That is, the LLM can be instructed to use only information that is exclusively contained in the provided input. For instance, the definition for an entity to be extracted can be provided, even if the LLM has in principle acquired knowledge about such entity definition during its training. Nonetheless, this approach can rely exclusively on prompt engineering, and might not provide strong guarantees about the produced output. Therefore, additional steps can be introduced with the aim of verifying LLM's answers. These steps might be of various types, including a second interaction with the LLM to perform a self-check activity: the LLM is prompted with a different request about the same task, with the objective of verifying consistency. Finally, CTI analysts can be kept in the output verification loop, including in the procedures of the STIX bundle review step.

A second challenge can be related to the input size limitations. An embodiment of the present invention can support 4 k tokens to be shared in between input and output size. This budget of tokens can suffice for: (i) the instruction prompt; (ii) any definition, such as what is a malware entity; (iii) the entire unstructured input text; and (iv) the produced output. Taking into account that reports in the dataset can be over 6 k words long, ways to distill information from the unstructured text can be introduced, before performing information extraction. One solution is to introduce the pre-processing steps in the pipelines, with the purpose of filtering, summarizing and selecting text from unstructured inputs. Like in the case of the self-check activity, LLM can be leveraged to perform text selection and summarization.

Entity and relation extraction pipeline: For the entity and relations pipeline, the preprocessing step can perform iterative summarization. First, the input text can be split in chunks of multiple sentences, then each chunk can be summarized using the LLM, with the following preprocessing prompt.

Write a concise summary of the following:

{text}

CONCISE SUMMARY:

The generated summaries can be joined together in a new text that is small enough to fit in the LLM input. This process could be repeated iteratively, however a single iteration can be sufficient.

The extraction stage can take as input the summarized report and perform as many requests as entities/relations to be extracted. Each provided prompt can contain: (i) a definition of the entity that should be extracted and/or (ii) a direct question naming such entity. A (partial) example of an entity extraction prompt follows.

Use the following pieces of context to answer the question at the end.

{context}

Question: Who/which is the target of the described attack?

After the extraction, the pipeline can perform a check-step, querying the LLM to confirm that the extracted entity/relation is present in the original text, and reporting an error in case of inconsistency. The check-step might not report any errors.

Attack pattern extraction pipeline: extracting attack patterns differs significantly from the extraction of simpler entities. As introduced earlier, a task can be about identifying behaviors described in the text and associating them to a definition of a behavior according to the MITRE ATT&CK Matrix taxonomy. Given the potentially large number of attack patterns in the MITRE ATT&CK Matrix, it can be inefficient (and expensive) to query the LLM directly for each attack pattern's definition and group of sentences in the input report. If a report has 10 paragraphs to inspect, and considering the over 400 techniques described the MITRE ATT&CK Matrix, over 4 k LLM requests could be used for a single report.

Another approach can be relied upon: the similarity between embeddings of the report's sentences and of the attack pattern's description examples can be checked. An embedding is the encoding of a sentence generated by a language model. The language model can be trained in such a way that sentences with similar meanings have embeddings that are close according to some distance metric (e.g., cosine similarity). Thus, the pipeline's extraction stage can compare the similarity between report sentences embeddings and the embeddings generated for the attack pattern examples provided by MITRE.

However, differently from the state of the art, pre-processing stage can be designed with the goal of generating different descriptions for the same potential attack patterns contained in the report. Here, an observation can be that an attack pattern might be described in very heterogeneous ways. Therefore, for the preprocessing the goal can be to generate multiple descriptions of the same attack pattern, to enhance the ability to discover similarities between such descriptions and the taxonomy's examples. In particular, three different description generation strategies can be introduced.

The first strategy can prompt the LLM to extract blocks of raw text or sentences that explicitly contain formal descriptions of attack patterns. The output of this strategy can be generally a paragraph, or in some cases a single sentence. The example attack pattern extraction preprocessing strategy #1 prompt follows.

Use the following portion of a long document to see if any of the text is relevant to answer the question. Return any relevant text verbatim.

{text}

Question: Which techniques are used by the attacker? Report only Relevant text, if any

The second strategy can leverage the LLM's reasoning abilities and prompt it to describe step-by-step the attack's events, seeking to identify implicit descriptions. The output of the second strategy can be a paragraph. The example attack pattern extraction preprocessing strategy #2 prompt follows.

Describe step by step the key facts in the following text:

{text}

KEY FACTS:

Finally, the third strategy can apply sentence splitting rules on the input text and provide single sentences as output.

All the outputs of the three selection strategies can be passed to the extraction step, where they can be individually checked for similarity with the MITRE taxonomy's examples. A similarity threshold can be empirically defined, after which the examined text block can be assigned to the attack pattern's classification of the corresponding MITRE taxonomy's example.

Evaluation: The desire to reduce the effort of CTI analysts in the organization resulted in the testing of many solutions and previous works. The evaluation of the embodiment of the present invention of aCTIon is presented herein in comparison to such solutions, considered as performance baselines. First, the implementation of the baselines (which were not always available in open source) and the evaluation metrics are presented, and secondly the results on the introduced dataset and an ablation study are presented.

Baselines selection and implementation: for the baselines implementation, the following principles were followed. First, at least one representative method for each family of NLP algorithms used in the literature was attempted to be included. Second, the original open-source implementation of the methods were used as possible. When this was not possible, the original implementation of the underlying NLP algorithm was relied on. Third, all methods using the same dataset where trained or fine-tuned when possible. The NLP-based methods that were tested can be leveraged in two different ways. One approach can be to train them on general data and (later referred as domain-agnostic models) use them directly. Another approach can be to further fine-tune them on CTI-specific data, before using them. Finally, the default hyperparameters can be used as described. The implemented solutions are disclosed herein, with embodiments of the present invention that focus on general entity and relations extraction, and embodiments of the present invention that deal with attack pattern extraction.

Entity and relations extraction: an NER solution is the basic building block of previous work. Three main families of models used in state-of-the-art NER tasks are Convolutional Neural Networks (CNN), BILSTM, and transformers. Among the previous work targeting structured CTI extraction, GRN relies on CNN, ThreatKG and CASIE are based on BILSTM, FLERT and LADDER are based on transformers. In the case of CNN and BiLSTM methods, models can be specifically trained end-to-end for the entity extraction task. Instead, approaches based on transformers can rely on pre-trained language models that are trained either on a general-domain corpus or a corpus that includes both general and domain-specific documents. These models can then be fine-tuned on a labeled dataset for the entity extraction task. For all approaches, a word-level CTI dataset can be used. This dataset can consist of a CTI corpus where individual words in a sentence have been annotated with tags that identify the named entities according to a specific CTI ontology and a specific format, such as the BIO format.

The labeling for this task can be complex and time consuming, and can require cross-domain expertise. CTI experts might also need to be familiar with NLP annotation techniques, which can make generating such datasets challenging. Thus, a publicly accessible dataset can be relied upon. All the selected models can be trained on the same dataset, using the same train/test/validation set split, to ensure a fair comparison. In an embodiment of the present invention, a word-level dataset can be used, which has also been used in previous works. This dataset can be chosen because it is the largest open-source dataset available and it is labeled according to an ontology that can be easily mapped to the STIX. The trained methods and tools performance can then be performed using the chosen dataset, since it can focus on CTI-metrics.

For CNN-based NER, the original open-source implementation of GRN can be used. For BiLSTM-based models, a domain-agnostic open-source implementation can be used. Indeed, ThreatKG might not provide an open-source version of their models, and while CASIE does provide an open-source implementation, it might not be directly adaptable to the dataset used to train the other models. Also, their dataset is labeled according to an ontology that can be very different from STIX and thus may not be able to be used for a fair comparison. Finally, for transformer-based models, two baselines can be presented: one is the original implementation of LADDER as a domain-specific tool, and the other one is a domain-agnostic NER implementation based on FLERT using an open-source implementation.

Attack pattern extraction: for the attack pattern extraction task, a wide range of approaches can be evaluated, namely template matching (TTPDrill, AttacKG), ML (rcATT, TRAM), LSTM (cybr2vec LSTM), and transformers (LADDER, SecBERT). All the baselines can provide either a pre-trained model or their own dataset to perform the training.

The methods can employ datasets based on the same taxonomy (e.g., MITRE ATT&CK) and that were directly extracted from the same source, either the description of the MITRE attack patterns or samples of MITRE attack pattern description (both provided by MITRE). Given the high similarity of the datasets in this case, each model can be trained using their own dataset. The methods can be evaluated using their original open-source implementations.

Performance metrics: each method can be compared against the Ground Truth (GT) from the dataset using following metrics:
Recall: fraction of unique entities in the GT that have been correctly extracted
Precision: fraction of unique extracted entities that are correct (e.g., part of the GT)
F1-score: harmonic mean of precision and recall

For the sake of clarity, in the rest of this section “entities” can refer to both entities and attack patterns, e.g. the outcomes of the two extraction tasks. From a high-level perspective, the recall indicates, for a given report, how much the GT entities have been covered by a method. The precision is instead impacted by the extracted entities which are wrong (e.g., false positive), e.g. the ones extracted with a wrong type or the ones that the human annotator has not selected as relevant enough. On the contrary, a true positive refers to an entity that has been correctly identified with the proper type and with the same text as in the GT. Finally, a false negative refers to an entity present in the GT but that has been missed by the method at hand.

A tool extracting all the possible entities of a given type can have a very high recall but a very low precision. Another tool can balance both metrics, e.g., when used to help the annotation task of the human operator that would otherwise spend a lot of time in checking results with many false positives. To further investigate this aspect, the number of entities reported by each tool can be provided and compared to the numbers from the GT. This investigation can be performed for the attack pattern extraction task because, based on a simple analysis on the GT, there are an order of magnitude more attack patterns than the other types of entities, making this issue particularly important.

In the following subsections, these metrics can be computed for malware, threat actor, identity pointed by a targets relation (which can be referred to as target), and attack pattern. The same methodology can be adopted of computing the metrics per each report, and then providing aggregate statistics. Given the nature of the GT (with some reports having just 0 or 1 entity of a given type), some metrics exhibit a bimodal distribution across the reports, e.g. they can be either 0 or 1. In order to provide better visibility of the underlying distribution of the values, violin plots were selected in place of boxplots. Still, to show at-a-glance the data range, both the average across reports (with a marker) and the 25th and 75th percentiles (as vertical bars) are reported.

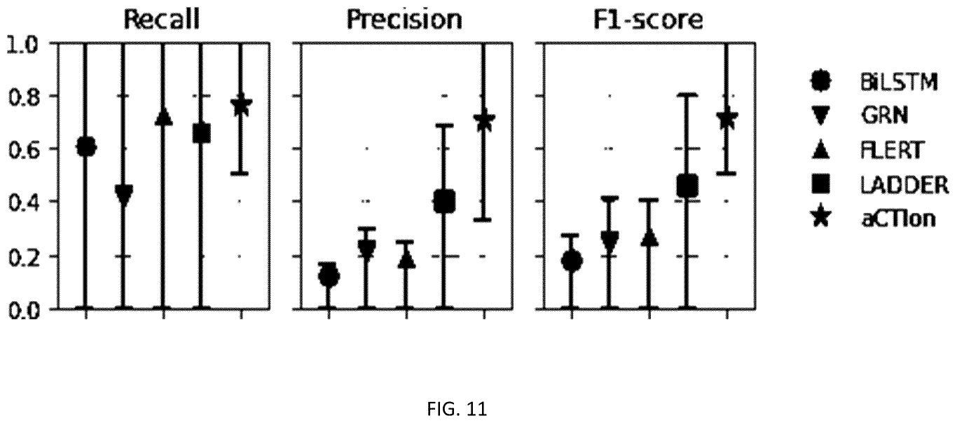

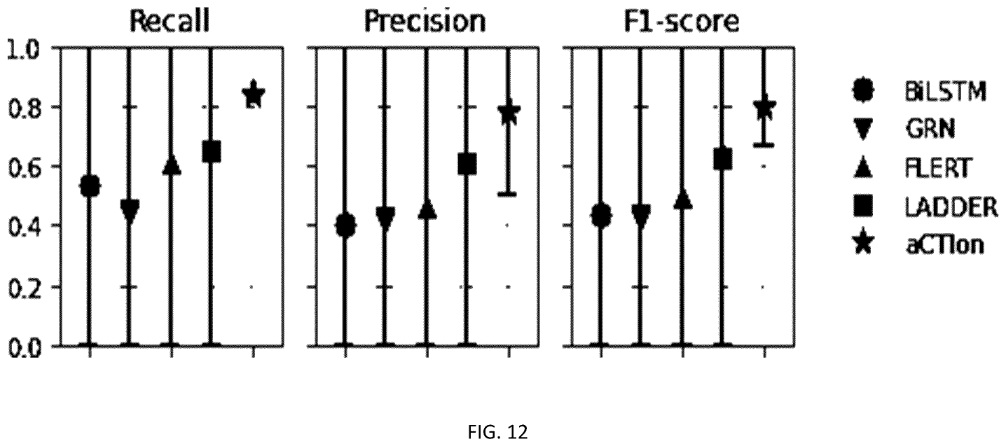

Entity extraction: FIGS. 11 and 12 show the results for aCTIon against the baselines for malware and threat actor entities, respectively. aCTIon outperforms the other baselines in terms of recall, precision, and consequently F1-score, for both entity extraction tasks. aCTIon achieves an average recall, precision and F1-score of 77%, 71% and 72%, respectively, for the malware entity extraction and 84%, 78% and 80% for the extraction of threat actor entities. This is an increment of over 25% points for malware, and about 20% points for threat actor when comparing the F1-score with the best performing baseline (LADDER). To explain this performance difference, where the baselines fail were inspected, and two main cases were identified: (i) baselines can fail to understand when an entity is not relevant for the target STIX bundle; and (ii) they can tend to wrongly include entities that are conceptually close to the entity of interest (e.g., they select a named software in place of a malware).

For example, when considering the example report, the baselines can identify HelloXD as malware, resulting in the same recall performance (for this specific report) to that achieved by aCTIon. However, the precision can be much lower. This is because baseline methods can include entities such as Lockbit 2.0 and x4k (the name of the threat actor and their several aliases) among the detected malwares. Furthermore, they can also include a wide range of legitimate applications such as Tox, UPX, Youtube, and ClamAV. For instance in the following extract, in contrast to aCTIon, baselines identify ClamAV as a malware:

“led us to believe the ransomware developer may like using the ClamAV branding for their ransomware.”

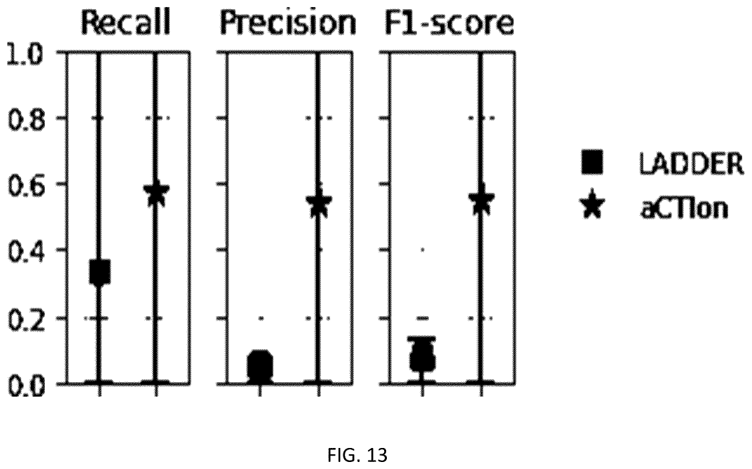

FIG. 13 shows the results for extracting target entities, where aCTIon outscored LADDER in recall, precision, and F1 score. This type of entity is trickier, since it can require to understand both named entities, and then the relation among them. FIG. 13: entity extraction, target. LADDER and aCTIon support the extraction of this type of entity, which can involve the assessment of relationships among entities. Consider the following extract:

“HelloXD is a ransomware family performing double extortion attacks that surfaced in November 2021. During our research, we observed multiple variants impacting Windows and Linux systems.”

The above sentences describe the targets of the attack: “Windows and Linux systems.” In STIX, they can be classified with the generic identity class, which can include classes of individuals, organizations, systems, or groups. To correctly identify the target entity, it may be necessary to understand if the identity node is an object of a “target” relation.

Among the considered baselines, LADDER is capable of extracting this type of entity, as it is equipped with a relation extraction model in addition to NER components. Despite the complexity of this task, aCTIon demonstrates effectiveness by significantly outperforming LADDER also in this case (about 50% points higher F1-score).

Attack pattern extraction: for the attack pattern extraction, a subset of 127 reports were focused on that do not include in the text a list or a table of MITRE Techniques in the well-defined Txxx format. For AttacKG, results are reported for 120 reports because the processing of each of the remaining 7 was interrupted after more than 24 hours, a time significantly longer than any manual analysis. T1573 refers to the MITRE Technique Encrypted Channel.

Attack patterns reported with such well-formed format can be extracted with a regex-based approach, and could therefore be detected.

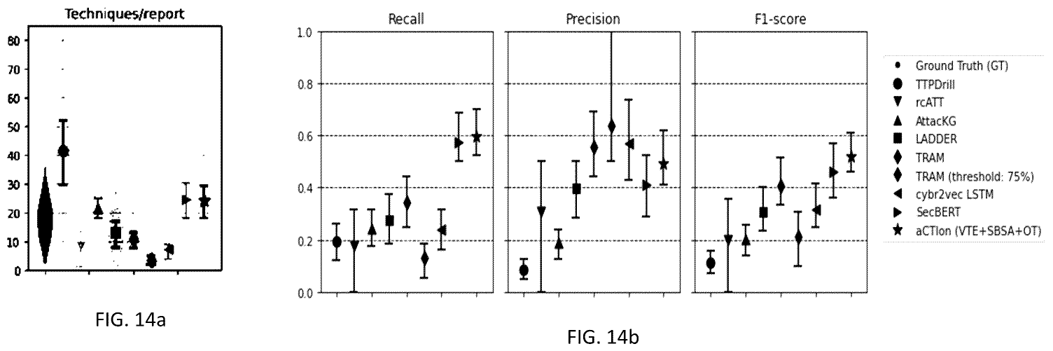

FIG. 14a and FIG. 14b: Attack pattern extraction. aCTIon outperforms other methods on recall, while achieving a good precision, thereby obtaining about 10% pts improvement on the F1-score compared to the best performing baseline. The first plot of FIG. 14a reports the number of attack pattern extracted from each report by different methods (apart from LADDER, the baselines are different from those used for the previous task). The plots of FIG. 14b report instead the recall, precision and F1-score performance metrics. From a high-level perspective the baseline methods can be divided into two groups. The first group can include “conservative” methods, e.g., those that tend to limit the number of attack patterns extracted from each report, resulting in a lower average number compared to the GT, namely rcATT, LADDER, TRAM and cybr2vec LSTM. The first violin plot in FIG. 14a indicates the real number of techniques per report. This group is characterized by recall values that are significantly lower than those of precision. The second group can include instead methods that have an average number of extracted attack patterns higher than the GT, and with recall similar to precision, namely TTPDrill, AttacKG and SecBERT. In the first group, TRAM offers the best performance (F1-score), while in the second group, SecBERT offers the overall best performance.

In addition to being the best within their respective group, these two methods can represent two different approaches to the attack pattern extraction. Indeed, the former, TRAM, is a framework designed to assist an expert in manual classification, e.g., its output should be reviewed by an expert, so it can be important to have high precision and keep the number of attack patterns to be verified low. This can be achieved, e.g., by increasing TRAM's minimum confidence score from 25% (its default value) to 75%. On the other hand, the latter, SecBERT, can be designed to be fully automated.

aCTIon outperforms all the baselines in terms of overall performance (F1-score) by about 10% points. The recall is also higher than any other solution, and the average precision is about 50%. These results can make a manual verification by CTI analysts manageable: the average number of attack patterns extracted per-report is 25 (cf. FIG. 14a).

Ablation study: an ablation study was conducted on the preprocessing step for both the entity and attack pattern extraction pipelines. Indeed, it is helpful to understand how information is selected and filtered in this step.

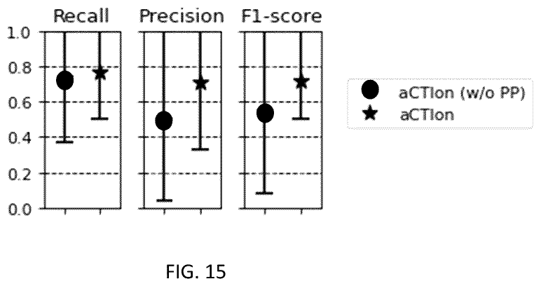

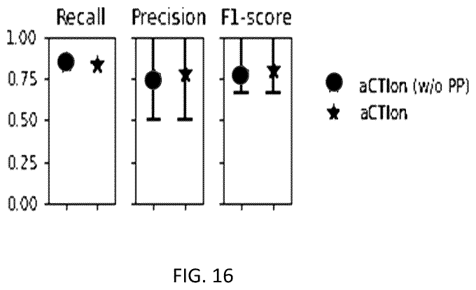

For entity extraction, a configuration in which the preprocessing step was included (aCTIon) can be compared to a configuration where it was omitted (aCTIon (w/o PP)). When omitted, the input report was provided in separate chunks if larger than the available input size. FIGS. 15 and 16 present the performance for the two different configurations when extracting malware and threat actors entities, respectively. The decrease in precision for aCTIon (w/o PP) was expected because non-relevant information was still present in the text during processing. Additionally, since only a few threat actors are usually present in the same report, the drop in performance was more noticeable for the malware entity.

It is noteworthy that the preprocessing step does not result in any decrease in recall, indicating that no relevant information is lost in the summary produced by the LLMs.

Additionally, for malware entities, the recall on preprocessed text is even slightly higher. Reformulating and summarizing concepts during preprocessing can thus aid in the extraction process.

In the case of attack pattern extraction, the preprocessing module can be utilized to select and enhance text extracts that potentially contain descriptions of attack patterns. The objective of the ablation study can be to examine how different preprocessing strategies contribute to identifying such descriptions. Four variants can be presented of the method that correspond to various preprocessing configurations.

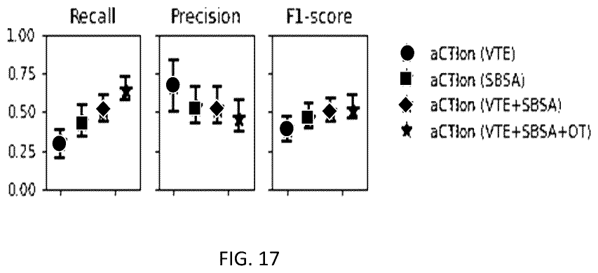

The first configuration, aCTIon (VTE), can select verbatim text excerpts (e.g., the strategy #1 referenced above) that may contain an attack pattern. This can result in a few attack patterns per report, with high precision (above 67%). However, it can have lower recall, since it is unusual for all attack patterns to be explicitly described in the text. In the second configuration, aCTIon (SBSA) (e.g., strategy #2), the preprocessing can be configured to describe the step-by-step actions performed during the attack, aiming to capture implicit or not-obvious descriptions of attack patterns. Using this configuration, the global performance (F1-score) of the best state-of-the-art method (SecBERT) can be matched, while outputting on average 14.4 attack patterns per report—on average, half of what is produced by SecBERT. The third configuration, aCTIon (VTE+SBSA), can use both preprocessing strategies together, resulting in improved performance. Additionally, it shows that the proposed preprocessing methods extract non-overlapping, complementary information. Finally, the fourth preprocessing configuration, aCTIon (VTE+SBSA+OT), can be chosen and labeled aCTIon in FIG. 14, reported here again. As can be seen for FIG. 17, the four configurations exhibited varied degrees of performance with the fourth configuration exhibiting the highest recall and F1 score, while the first configuration exhibited the highest precision.

Discussion: The evaluation focused on malware, threat actor, target, and attack pattern entities. This was the case because these entities enabled direct comparison with previous work, e.g., other entities were not widely supported by other tools. As a result, the evaluation did not extensively cover the extraction of relations. The extraction of target includes relation extraction (of type targets), and could be compared to LADDER that supports it (cf. FIG. 13). However, aCTIon can extract any relation defined in the STIX's ontology, and therefore the performance is assessed also in that regard. For example, for all relations between malware, threat actor, and identity, e.g., relation of types targets and uses, aCTIon achieves 73% recall and 88% precision on average. A second aspect is aCTIon's ability to handle languages beyond English. In fact, the chosen dataset includes 13 additional reports in languages other than English, e.g. Chinese, Japanese. On such reports, aCTIon performed consistently with the reported results.

Deployment advantages: In addition to performance results, in a practical setting, ease of deployment and maintenance can be considered. Compared to previous work, the reliance of aCTIon on LLMs can remove the need to collect, annotate, and maintain datasets for the different components of the previous work's pipelines (e.g., NER components). Furthermore, previous work, e.g., LADDER, can make extensive use of hand-crafted heuristics to clean and filter the classification output (e.g., allow-lists of know non-malicious software). Heuristics also require continuous maintenance and adaptation. In contrast, aCTIon does not necessarily require the collection and annotation of datasets, nor the use of hand-crafted heuristics.

Advantageously, aCTIon provides for the proper use and integration of LLMs in an information extraction pipeline. Tests with this technology confidence grew that tools like aCTIon can already do most of the heavy lifting in place of CTI analysts, for structured CTI extraction. Performance could continue to improve with the development of more powerful LLMs (e.g., GPT4) that allow for larger input sizes and better reasoning capabilities. Therefore, the recall and precision metrics could further improve without significant changes to aCTIon.

Other issues: the current precision and recall of aCTIon is within the 60%-90% range for most entities. This can be already in line with the performance of a CTI analyst, and unlike human analysts, aCTIon keeps consistent performance over time without being affected by tiredness. In fact, many misclassifications could be an artifact of the ambiguous semantics associated with CTI and the related standard ontologies. For example, what is considered a relevant entity by an analyst may differ. Defining clear semantics for CTI data remains an open challenge.

Related work: related work on LLMs and on structured CTI extraction have been incorporated by reference herein below, and other works also leverage the structured information. As mentioned, structured CTI can enable the investigation and monitoring activities inside an organization, e.g. threat hunting, based for example on TTPs. However, there are also other relevant uses. In particular, trend analysis and prediction of threats for proactive defense can take advantage of structured CTI. Adversary emulation tools like MITRE CALDERA can also benefit from structured CTI because they are typically fed with adversarial techniques based on e.g., MITRE ATT&CK.

Conclusion: a dataset can be introduced to benchmark the task of extracting structured CTI from unstructured text, and an embodiment of the present invention, aCTIon, can provide a solution to automate the task.

The dataset can be the outcome of months of work from CTI analysts, and can provide a structured STIX bundle for each of the 204 reports included. At the time of filing, the dataset is 34× larger than any other publicly available dataset for structured CTI extraction, and the only one to provide complete STIX bundles.

The embodiment of the present invention of aCTIon can be introduced, which in the embodiment is a framework that can leverage recent advances in LLMs to automate structured CTI extraction. To evaluate aCTIon, 10 different tools can be selected from the state-of-the-art and previous work, and re-implementing them if open source implementations are not available. The evaluation on the proposed benchmark dataset shows that aCTIon largely outperforms previous solutions. Currently, aCTIon is in testing for daily production deployment.

There has been a recent wave of announcements of security products based on LLMs to analyze and process CTI. However, the security community was still lacking a benchmark that would allow the evaluation of such tools on specific CTI analysts tasks. Furthermore, there is a lack of information about how LLMs could be leveraged in this area for the design of systems. The work disclosed herein can provide both a way to benchmark such new tools with the dataset and a first set of insights about the use of LLMs in CTI tasks.

| | LADDER | | | aCTIon | | |
|---|---|---|---|---|---|---|
| | Rec | Prec | F1 | Rec | Prec | F1 |
| Malware | 0.73 | 0.58 | 0.61 | 0.92 | 0.67 | 0.75 |
| Threat Actor | 0.46 | 0.42 | 0.44 | 0.69 | 0.65 | 0.67 |
| Victim | 0.31 | 0.19 | 0.21 | 0.54 | 0.54 | 0.54 |
| Attack Pattern | 0.01 | 0.08 | 0.01 | 0.44 | 0.52 | 0.46 |

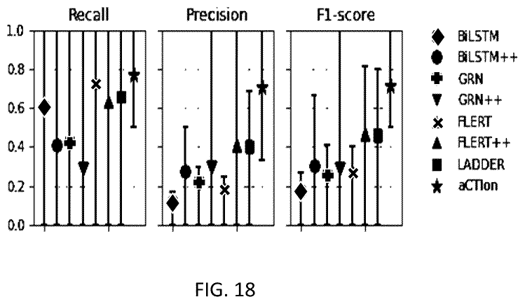

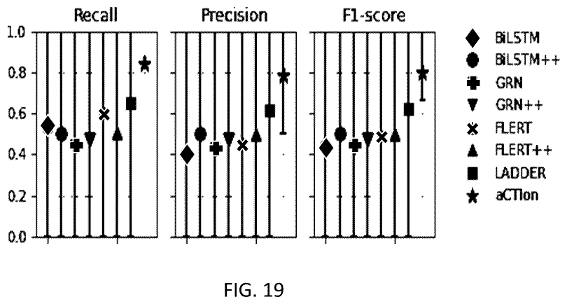

Baselines with heuristics: 3 additional baselines are considered where the same post-processing heuristics are applied provided by LADDER to each one of the other 3 baselines, e.g., BILSTM, GRN, and FLERT. These new baselines are named BiLSTM++, GRN++ and FLERT++, respectively. The post-processing heuristics were used by LADDER to remove noisy entities and solve some ambiguities produced by the NER module. As shown in FIGS. 18 and 19, the heuristics are able to increase the precision because some irrelevant entities can be filtered out. At the same time, however, the recall decreases, implying that the heuristics are also wrongly cutting out some information which is relevant. Remarkably, when extracting malware entities, FLERT++ is able to reach the F1-score performance of LADDER, which however still keeps its role of best performing baseline for both types of entity.

Multi-language support: Not all the CTI sources are in English language. For example, the dataset includes 13 additional reports (e.g. apart from the 204) in languages other than English, e.g. Chinese, Japanese and Korean. This can be an issue for the analyst that not only should have expertise in the cybersecurity domain, but would also need to know fluently more than one language. Automated tools can be used when specialized on multiple languages, and this is typically not the case. Among the baselines, LADDER includes a multi-language model (XLM-ROBERTa) that can work on non-english reports. However, this applies to its NER components for the entity extraction task. Indeed, when considering its 3-stages attack pattern extraction pipeline, all three stages (based on ROBERTa and Sentence-BERT), support the English language, making them potentially unsuitable for other languages. An embodiment of the present invention is based on an LLM that during training was exposed to a huge corpus of text including a variety of languages and thus can process reports in languages other than English.

The performance of aCTIon was evaluated against LADDER for the entity extraction task and eported in Table 3 the average performance across the 13 reports. In general, aCTIon and LADDER present a gap of performance comparable to the one observable when analyzing the English reports (9% point-35% point). In the case of attack pattern extraction, aCTIon is able to produce a usable result, and its performances are comparable to what is obtained for English reports.

Relationship extraction: evaluating relationship extraction task can be more complex than regular entity extraction. In fact, it can be helpful to include negative samples of relationships in order to verify that the classifier is able not only to confirm the existence of a relation among entities, but also its lack. Generating random non-existent syntactically correct links is an approach commonly adopted in the state-of-the-art.

Thus, a benchmark is defined to evaluate aCTIon performance in extracting STIX relations between entities. As positive samples (e.g. existing relations between existing entities) all the relations between malware, threat actor, and identity entities that were present in the STIX representation of the report (e.g. as they were extracted by the CTI analyst) are used. As negative samples (e.g. not existing relations between existing entities) a set of randomly generated relations between entities that are present in the text are used. This set may also include entities which are extracted by the entity extraction task but that have been then filtered out in the final STIX representation by the CTI analyst (e.g. Lockbit 2.0 in the HelloXD report). Positive samples and negative samples form the evaluation dataset.

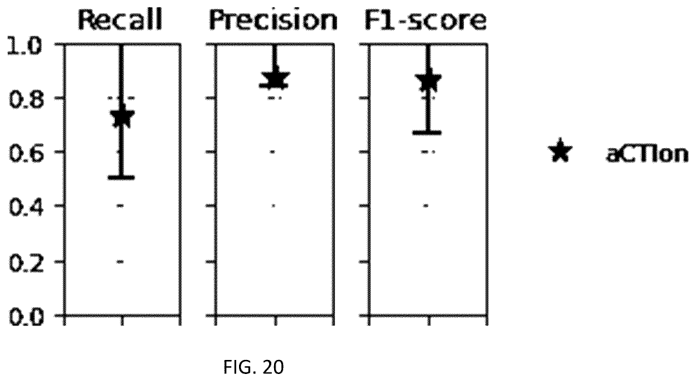

Furthermore, since the scope of the test is to benchmark just the relation extraction capabilities, entities extracted by aCTIon (that would automatically filter out some negative samples) are not used, but this dataset is built directly from the STIX representation provided by the CTI analyst. aCTIon is configured to preprocess the text using the same compression techniques described herein and is prompted to extract the relation between two entities using a direct question. FIG. 20 shows the results for all aCTIon relations between malware, threat actor, and identity entities, e.g., relations of types targets and uses. On average, aCTIon achieves 73% recall, 88% precision and 86% f1-score.

The following references are hereby incorporated by reference herein:
2023, AttacKG GitHub repository. https://github.com/li-zhenyuan/Knowledge-enhanced-Attack-Graph. [Online; accessed 13 Apr. 2023].
2023, BiLSTM-CNN-CRF GitHub repository. https://github. com/UKPLab/emnlp2017-bilstm-cnn-crf. [Online; accessed 13 Apr. 2023].
2023, Cyber Threat Alliance (CTA). https://www.cyberthreatalliance.org/. [Online; accessed 13 Apr. 2023].
2023, FLAIR GitHub repository. https://github.com/flairNLP/flair. [Online; accessed 13 Apr. 2023].
2023, GRN GitHub repository. https://github.com/microsoft/vert-papers/tree/master/papers/GRN-NER. [Online; accessed 13 Apr. 2023].
2023, Hazy Research—From Deep to Long Learning? https://hazyresearch.stanford.edu/blog/2023-03-27-long-learning. [Online; accessed 13 Apr. 2023].
2023, Introducing AI-powered insights in Threat Intelligence. https://cloud.google.com/blog/products/identity-security/rsa-introducing-ai-powered-insights-threat-intelligence. [Online; accessed 4 May 2023].
2023, Introducing Microsoft Security Copilot. https://www.microsoft.com/en-us/security/business/ai-machinelearning/microsoft-security-copilot. [Online; accessed 4 May 2023].
2023, Introducing Recorded Future AI: AI-driven intelligence to elevate your security defenses. https://www.recordedfuture.com/introducing-recorded-future-ai. [Online; accessed 4 May 2023].
LADDER GitHub repository. https://github.com/aiforsec22/IEEEEuroSP23. [Online; accessed 13 Apr. 2023].
MITRE ATT&CK. https://attack.mitre.org/. [Online; accessed 13 Apr. 2023].
MITRE CALDERA GitHub repository. https://github.com/mitre/caldera. [Online; accessed 13 Apr. 2023].
OpenAI API. https://platform.openai.com/docs/api-reference. [Online; accessed 13 Apr. 2023].
OpenAI GPT-3.5. https://platform.openai.com/docs/models/gpt-3-5. [Online;
accessed 13 Apr. 2023].
rcATT GitHub repository. https://github.com/vlegoy/rcATT. [Online; accessed 13 Apr. 2023].
SecBERT GitHub repository. https://github.com/dessertlab/cti-to-mitre-with-nlp. [Online; accessed 13 Apr. 2023].
TRAM GitHub repository. https://github.com/center-for-threat-informed-defense/tram/. [Online; accessed 13 Apr. 2023].
TTPDrill GitHub repository. https://github.com/SkyBulk/TTPDrill-0.3. [Online; accessed 13 Apr. 2023].
Ehsan Aghaei, Xi Niu, Waseem Shadid, and Ehab Al-Shaer. 2023, SecureBERT: A Domain-Specific Language Model for Cybersecurity. In Security and Privacy in Communication Networks: 18th EAI International Conference, SecureComm 2022, Virtual Event, October 2022, Proceedings. Springer, 39-56.
Alan Akbik, Tanja Bergmann, Duncan Blythe, Kashif Rasul, Stefan Schweter, and Roland Vollgraf. 2019, FLAIR: An easy-to-use framework for state-of-the-art NLP. In Proceedings of the 2019 conference of the North American chapter of the association for computational linguistics (demonstrations). 54-59.
Rawan Al-Shaer, Jonathan M Spring, and Eliana Christou. 2020, Learning the associations of mitre att & ck adversarial techniques. In 2020 IEEE Conference on Communications and Network Security (CNS). IEEE, 1-9.
Md Tanvirul Alam, Dipkamal Bhusal, Youngja Park, and Nidhi Rastogi. 2022, Looking Beyond IoCs: Automatically Extracting Attack Patterns from External CTI. arXiv preprint arXiv: 2211.01753 (2022).
Andy Applebaum, Doug Miller, Blake Strom, Chris Korban, and Ross Wolf. 2016, Intelligent, automated red team emulation. In Proceedings of the 32nd Annual Conference on Computer Security Applications. 363-373.
Yejin Bang, Samuel Cahyawijaya, Nayeon Lee, Wenliang Dai, Dan Su, Bryan Wilie, Holy Lovenia, Ziwei Ji, Tiezheng Yu, Willy Chung, et al. 2023, A multitask, multilingual, multimodal evaluation of chatgpt on reasoning, hallucination, and interactivity. arXiv preprint arXiv: 2302.04023 (2023).
Sean Barnum. 2012, Standardizing cyber threat intelligence information with the structured threat information expression (stix). Mitre Corporation 11 (2012), 1-22.
Rishi Bommasani, Drew A Hudson, Ehsan Adeli, Russ Altman, Simran Arora, Sydney von Arx, Michael S Bernstein, Jeannette Bohg, Antoine Bosselut, Emma Brunskill, et al. 2021, On the opportunities and risks of foundation models. arXiv preprint arXiv: 2108.07258 (2021).
Matt Bromiley. 2016, Threat intelligence: What it is, and how to use it effectively. SANS Institute InfoSec Reading Room 15 (2016), 172.
Tom Brown, Benjamin Mann, Nick Ryder, Melanie Subbiah, Jared D Kaplan, Prafulla Dhariwal, Arvind Neelakantan, Pranav Shyam, Girish Sastry, Amanda Askell, et al. 2020, Language models are few-shot learners. Advances in neural information processing systems 33 (2020), 1877-1901.
Hui Chen, Zijia Lin, Guiguang Ding, Jianguang Lou, Yusen Zhang, and Borje Karlsson. 2019, GRN: Gated relation network to enhance convolutional neural network for named entity recognition. In Proceedings of the AAAI Conference on Artificial Intelligence, Vol. 33. 6236-6243.
Veronica Chierzi and Fernando Mercês. 2021, Evolution of IoT Linux Malware: A MITRE ATT&CK TTP Based Approach. In 2021 APWG Symposium on Electronic Crime Research (eCrime). IEEE, 1-11.
Alexis Conneau, Kartikay Khandelwal, Naman Goyal, Vishrav Chaudhary, Guillaume Wenzek, Francisco Guzmán, Edouard Grave, Myle Ott, Luke Zettlemoyer, and Veselin Stoyanov. 2019, Unsupervised cross-lingual representation learning at scale. arXiv preprint arXiv: 1911.02116 (2019).
Roman Daszczyszak, Dan Ellis, Steve Luke, and Sean Whitley. 2019, Ttp-based hunting. Technical Report. MITRE CORP MCLEAN VA.
Peng Gao, Xiaoyuan Liu, Edward Choi, Sibo Ma, Xinyu Yang, Zhengjie Ji, Zilin Zhang, and Dawn Song. 2022, ThreatKG: A Threat Knowledge Graph for Automated Open-Source Cyber Threat Intelligence Gathering and Management. arXiv preprint arXiv: 2212.10388 (2022).
Peng Gao, Xiaoyuan Liu, Edward Choi, Bhavna Soman, Chinmaya Mishra, Kate Farris, and Dawn Song. 2021, A system for automated open-source threat intelligence gathering and management. In Proceedings of the 2021 International Conference on Management of Data. 2716-2720.
Peng Gao, Fei Shao, Xiaoyuan Liu, Xusheng Xiao, Zheng Qin, Fengyuan Xu, Prateek Mittal, Sanjeev R Kulkarni, and Dawn Song. 2021, Enabling efficient cyber threat hunting with cyber threat intelligence. In 2021 IEEE 37th International Conference on Data Engineering (ICDE). IEEE, 193-204.
Jerry L Hintze and Ray D Nelson. 1998, Violin plots: a box plot-density trace synergism. The American Statistician 52, 2 (1998), 181-184.
Ghaith Husari, Ehab Al-Shaer, Mohiuddin Ahmed, Bill Chu, and Xi Niu. 2017, Ttpdrill: Automatic and accurate extraction of threat actions from unstructured text of cti sources. In Proceedings of the 33rd annual computer security applications conference. 103-115.
Yong-Woon Hwang, Im-Yeong Lee, Hwankuk Kim, Hyejung Lee, and Donghyun Kim. 2022, Current status and security trend of OSINT. Wireless Communications and Mobile Computing 2022 (2022).
Ziwei Ji, Nayeon Lee, Rita Frieske, Tiezheng Yu, Dan Su, Yan Xu, Etsuko Ishii, Ye Jin Bang, Andrea Madotto, and Pascale Fung. 2023, Survey of hallucination in natural language generation. Comput. Surveys 55, 12 (2023), 1-38.
Jacob Devlin Ming-Wei Chang Kenton and Lee Kristina Toutanova. 2019, BERT: Pre-training of Deep Bidirectional Transformers for Language Understanding. In Proceedings of NAACL-HLT. 4171-4186.
Takeshi Kojima, Shixiang Shane Gu, Machel Reid, Yutaka Matsuo, and Yusuke Iwasawa. 2022, Large language models are zero-shot reasoners. arXiv preprint arXiv: 2205.11916 (2022).
Viet Dac Lai, Nghia Trung Ngo, Amir Pouran Ben Veyseh, Hieu Man, Franck Dernoncourt, Trung Bui, and Thien Huu Nguyen. 2023, ChatGPT Beyond English: Towards a Comprehensive Evaluation of Large Language Models in Multilingual Learning. arXiv preprint arXiv: 2304.05613 (2023).
Nayeon Lee, Wei Ping, Peng Xu, Mostofa Patwary, Pascale N Fung, Mohammad Shoeybi, and Bryan Catanzaro. 2022. Factuality enhanced language models for open-ended text generation. Advances in Neural Information Processing Systems 35 (2022), 34586-34599.
Valentine Legoy, Marco Caselli, Christin Seifert, and Andreas Peter. 2020. Automated retrieval of att&ck tactics and techniques for cyber threat reports. arXiv preprint arXiv: 2004.14322 (2020).
Zhenyuan Li, Jun Zeng, Yan Chen, and Zhenkai Liang. 2022, AttacKG: Constructing technique knowledge graph from cyber threat intelligence reports. In Computer Security-ESORICS 2022: 27th European Symposium on Research in Computer Security, Copenhagen, Denmark, Sep. 26-30, 2022, Proceedings, Part I. Springer, 589-609.
Swee Kiat Lim, Aldrian Obaja Muis, Wei Lu, and Chen Hui Ong. 2017, Malwaretextdb: A database for annotated malware articles. In Proceedings of the 55th Annual Meeting of the Association for Computational Linguistics (Volume 1: Long Papers). 1557-1567.
Pengfei Liu, Weizhe Yuan, Jinlan Fu, Zhengbao Jiang, Hiroaki Hayashi, and Graham Neubig. 2023, Pre-train, prompt, and predict: A systematic survey of prompting methods in natural language processing. Comput. Surveys 55, 9 (2023), 1-35.
Yinhan Liu, Myle Ott, Naman Goyal, Jingfei Du, Mandar Joshi, Danqi Chen, Omer Levy, Mike Lewis, Luke Zettlemoyer, and Veselin Stoyanov. 2019, Roberta: A robustly optimized bert pretraining approach. arXiv preprint arXiv: 1907.11692 (2019).
Xuezhe Ma and Eduard Hovy. 2016, End-to-end Sequence Labeling via Bi-directional LSTM-CNNs-CRF. In Proceedings of the 54th Annual Meeting of the Association for Computational Linguistics (Volume 1: Long Papers). 1064-1074.
Sadegh M Milajerdi, Birhanu Eshete, Rigel Gjomemo, and V N Venkatakrishnan. 2019, Poirot: Aligning attack behavior with kernel audit records for cyber threat hunting. In Proceedings of the 2019 ACM SIGSAC conference on computer and communications security. 1795-1812.
Kris Oosthoek and Christian Doerr. 2019, Sok: Att&ck techniques and trends in windows malware. In Security and Privacy in Communication Networks: 15th EAI International Conference, SecureComm 2019, Orlando, FL, USA, Oct. 23-25, 2019, Proceedings, Part I 15. Springer, 406-425.
Vittorio Orbinato, Mariarosaria Barbaraci, Roberto Natella, and Domenico Cotroneo. 2022, Automatic Mapping of Unstructured Cyber Threat Intelligence: An Experimental Study: (Practical Experience Report). In 2022 IEEE 33rd International Symposium on Software Reliability Engineering (ISSRE). IEEE, 181-192.
Ankur Padia, Arpita Roy, Taneeya W Satyapanich, Francis Ferraro, Shimei Pan, Youngja Park, Anupam Joshi, and Tim Finin. 2018, UMBC at SemEval-2018 Task 8: Understanding text about malware. UMBC Computer Science and Electrical Engineering Department (2018).
Youngja Park and Taesung Lee. 2022, Full-Stack Information Extraction System for Cybersecurity Intelligence. In Proceedings of the 2022 Conference on Empirical Methods in Natural Language Processing: Industry Track. 531-539.
Lance A Ramshaw and Mitchell P Marcus. 1999, Text chunking using transformation-based learning. Natural language processing using very large corpora (1999), 157-176.
Nils Reimers and Iryna Gurevych. 2017, Reporting Score Distributions Makes a Difference: Performance Study of LSTM-networks for Sequence Tagging. In Proceedings of the 2017 Conference on Empirical Methods in Natural Language Processing. 338-348.
Nils Reimers and Iryna Gurevych. 2019, Sentence-BERT: Sentence Embeddings using Siamese BERT-Networks. In Proceedings of the 2019 Conference on Empirical Methods in Natural Language Processing and the 9th International Joint Conference on Natural Language Processing (EMNLP-IJCNLP). 3982-3992.
Kiavash Satvat, Rigel Gjomemo, and V N Venkatakrishnan. 2021, Extractor: Extracting attack behavior from threat reports. In 2021 IEEE European Symposium on Security and Privacy (EuroS&P). IEEE, 598-615.
Taneeya Satyapanich, Francis Ferraro, and Tim Finin. 2020, Casie: Extracting cybersecurity event information from text. In Proceedings of the AAAI conference on artificial intelligence, Vol. 34. 8749-8757.
Stefan Schweter and Alan Akbik. 2020, Flert: Document-level features for named entity recognition. arXiv preprint arXiv: 2011.06993 (2020).
Y. Sharma, E. Giunchiglia, S. Birnbach, and I. Martinovic. [n. d.]. To TTP or not to TTP? Exploiting TTPs to improve ML-based malware detection. In 2023 IEEE International Conference on Cyber Security and Resilience (CSR).
Ashish Vaswani, Noam Shazeer, Niki Parmar, Jakob Uszkoreit, Llion Jones, Aidan N Gomez, Łukasz Kaiser, and Illia Polosukhin. 2017. Attention is all you need. Advances in neural information processing systems 30 (2017).
Thomas D Wagner, Khaled Mahbub, Esther Palomar, and Ali E Abdallah. 2019, Cyber threat intelligence sharing: Survey and research directions. Computers & Security 87 (2019), 101589.
Jason Wei, Yi Tay, Rishi Bommasani, Colin Raffel, Barret Zoph, Sebastian Borgeaud, Dani Yogatama, Maarten Bosma, Denny Zhou, Donald Metzler, et al. 2022, Emergent abilities of large language models. arXiv preprint arXiv: 2206.07682 (2022).
Jeff Wu, Long Ouyang, Daniel M Ziegler, Nisan Stiennon, Ryan Lowe, Jan Leike, and Paul Christiano. 2021, Recursively summarizing books with human feedback. arXiv preprint arXiv: 2109.10862 (2021).
Bishan Yang, Wen-tau Yih, Xiaodong He, Jianfeng Gao, and Li Deng. 2015, Embedding entities and relations for learning and inference in knowledge bases. In 3rd International Conference on Learning Representations (2015).
Shunyu Yao, Jeffrey Zhao, Dian Yu, Nan Du, Izhak Shafran, Karthik Narasimhan, and Yuan Cao. 2022. ReAct: Synergizing Reasoning and Acting in Language Models. arXiv preprint arXiv: 2210.03629 (2022).

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A computer-implemented method for extracting and mapping structured information to a data model, the method comprising:
obtaining text data from one or more unstructured data sources;
determining rephrased text data using a Large Language Model (LLM), a preprocessing prompt, and the text data;
determining extracted data using the LLM, an extraction prompt, the data model, and the rephrased text data; and
mapping the extracted data to the data model.

2. The method of claim 1, further comprising:
outputting the extracted data to a user interface for user review;
receiving user input on the extracted data;
determining a revised extraction prompt based on the user input; and
determining further extracted data using the LLM, the revised extraction prompt, the data model, and the rephrased text data,
wherein the further extracted data is used as the extracted data that is mapped to the data model.

3. The method of claim 1, wherein the one or more unstructured data sources include security reports, and the text data includes cyber threat intelligence (CTI) information related to a security incident.

4. The method of claim 1, further comprising obtaining further text data from internet sources based on a determination that the text data does not contain sufficient information to be processed by the LLM, wherein determining the rephrased text is based on the text data and the further text data.

5. The method of claim 4, wherein the text data and/or the further text data is obtained by parsing the one or more unstructured data sources and/or the internet sources based on entities defined by the data model.

6. The method of claim 1, wherein determining the rephrased text data comprises:
obtaining one or more text chunks from the text data based on an input capacity of the LLM; and
inputting the preprocessing prompt and a first text chunk, of the one or more text chunks, into the LLM to obtain summarized rephrased text data for the first text chunk as the rephrased text data, wherein the summarized rephrased text data comprises less text data than the first text chunk, and wherein determining the extracted data is based on the summarized rephrased text data.

7. The method of claim 6, further comprising:
inputting a further preprocessing prompt and a second text chunk, of the one or more text chunks, into the LLM to obtain second summarized rephrased text data for the second text chunk, wherein the second summarized rephrased text data comprises less text data than the second text chunk, and
wherein determining the extracted data is further based on the second summarized rephrased text data.

8. The method of claim 1, wherein determining the rephrased text data further comprises:
inputting the preprocessing prompt and the text data into the LLM to obtain expanded rephrased text for the text data, wherein the expanded rephrased text comprises an expansion of the text data, and
wherein determining the extracted data is further based on the expanded rephrased text data.

9. The method of claim 8, wherein the expansion of the text data comprises at least a portion of the text data and new text indicating a different description of information from the text data.

10. The method of claim 1, further comprising:
outputting the rephrased text data to a user interface for user review;
receiving user input on the rephrased text data;
determining a revised preprocessing prompt based on the user input; and
determining further rephrased text data based on using the LLM, the revised preprocessing prompt, and the text data sources,
wherein the further rephrased text data is used as the rephrased text data in determining the extracted data.

11. The method of claim 1, further comprising:
obtaining entities of the data model using the extraction prompt and the LLM, wherein the extraction prompt queries the LLM to extract the entities of the data model from the rephrased text data,
wherein the data model is a structured threat information expression (STIX) data model, and
wherein mapping the extracted data to the data model further comprises mapping the extracted entities to the data model and outputting the mapped data model to a user via a user interface.

12. The method of claim 11, wherein:
the text data includes cyber threat intelligence (CTI) information, and the entities include one or more of: malware, threat actor, target and vulnerability; or
the text data includes medical records, and the entities include one or more of: patients, doctors, treatments, hospitals and drugs.

13. The method of claim 1, further comprising:
determining further rephrased text data using the LLM, a further preprocessing prompt different than the preprocessing prompt, and the text data sources, and/or determining further extracted data using the LLM, a further extraction prompt different from the extraction prompt, the data model, and the rephrased text data; and
determining that the further rephrased text data is the same or substantially similar to the rephrased text data, or, that the further extracted data comprises a same extracted entity as the extracted data.

14. A computer system for extracting and mapping structured information to a data model, the computer system comprising one or more hardware processors which, alone or in combination, are configured to provide for execution of the following steps:
obtaining text data from one or more unstructured data sources;
determining rephrased text data using a Large Language Model (LLM), a preprocessing prompt, and the text data;
determining extracted data using the LLM, an extraction prompt, the data model, and the rephrased text data; and
mapping the extracted data to the data model.

15. A tangible, non-transitory computer-readable medium for extracting and mapping structured information to a data model, the computer system having instructions thereon which, upon being executed by one or more hardware processors, alone or in combination, provide for execution of the following steps:
obtaining text data from one or more unstructured sources;
determining rephrased text data using a Large Language Model (LLM), a preprocessing prompt, and the text data;
determining extracted data using the LLM, an extraction prompt, the data model, and the rephrased text data; and
mapping the extracted data to the data model.
